(19) United States
(12) Patent Application Publication
(10) Pub. No.: US 2017/0358161 A1
(43) Pub. Date: Dec. 14, 2017

(54) END-TO-END VERIFIABLE E-VOTING SYSTEM WITHOUT TALLYING AUTHORITIES

(71) Applicant: University of Newcastle Upon Tyne, New Castle Upon Tyne (GB)

(72) Inventors: Feng HAO, Newcastle Upon Tyne (GB); Siamak F. Shahandashti, Newcastle Upon Tyne (GB)

(21) Appl. No.: 15/582,447

(22) Filed: Apr. 28, 2017

(30) Foreign Application Priority Data
Apr. 29, 2016 (GB) 1607597.0

(51) Int. Cl. G07C 13/02; H04L 9/30; H04L 9/08

(52) U.S. Cl. CPC G07C 13/02; H04L 9/08; H04L 9/30

(57) ABSTRACT

A method for electronic voting is provided. The method comprises receiving a selection of a vote vᵢ from a voter, generating one or more first values associated with the voter, calculating one or more second values based on the one or more first values, providing a first type of receipt including the one or more second values to the voter, updating a tally, t, based on the vote vᵢ, updating a sum, s, based on the one or more first values, and publishing the receipt including the one or more second values.

### FIELD OF THE INVENTION

The present invention relates to an end-to-end verifiable e-voting system. In particular, certain embodiments of the present invention provide an end-to-end verifiable e-voting system that does not require a trusted tallying authority.

### BACKGROUND OF THE INVENTION

Direct-recording electronic (DRE) machines have been extensively used for in-person voting at polling stations around the world. In a typical process, a legitimate voter obtains a random token after being authenticated at the polling station. The voter then enters a private booth and presents the token to a DRE machine. The token is for one-time use and allows the voter to cast only one vote. Usually, the DRE machine has a touch screen to record the electronic vote directly from the voter (hence the name direct-recording electronic). The machine may tally the vote in real time, or store the votes in a memory card and tally later. In either case, the machine works like a black box: if an attacker maliciously changes the votes (or the tally thereof), it is unlikely that this will be noticed by the public.

Lack of assurance on the tallying integrity has been commonly regarded as a critical weakness of such DRE machines. To address this problem, several cryptographic protocols have been proposed. One technique (D. L. Chaum, “Secret-ballot receipts: True voter-verifiable elections”, IEEE Security & Privacy, 2(1):38-47, 2004) involves using visual cryptography to allow voters to verify the integrity of a DRE-based election. The assurance on the integrity includes guarantees that the votes are cast as intended, recorded as cast, and tallied as recorded. The fulfilment of all three guarantees constitutes the now widely accepted notion of end-to-end (E2E) verifiability.

Today, nearly all of the deployed DRE systems work like a black box and offer no guarantee on integrity; consequently, their use has been abandoned in several countries such as the Netherlands, Germany and Ireland. However, in many other countries, these (unverifiable) DRE machines continue to be extensively used.

Previous E2E schemes for DRE-based elections offer integrity assurance by introducing a set of trustworthy tallying authorities (TAs). Instead of the DRE directly recording the vote, the machine encrypts the vote on the fly under the public keys of the TAs. Each TA is responsible for safeguarding a share of the decryption key. When the voting is finished, a quorum of the TAs will jointly perform the decryption and subsequently the tallying process in a publicly verifiable manner.

The introduction of an external set of TAs however introduces difficulties in the implementation. In theory, the TAs should be selected from different parties with conflicting interests. They should have the expertise to be able to independently manage their own key shares and perform cryptographic operations (if they delegate the key management tasks, the delegates need to be trusted). A fairly high level of cryptographic and computing skills is expected from the TAs. Furthermore, the quorum should be set sufficiently large such that collusion among TAs is infeasible, but at the same time, sufficiently small such that the process is error-tolerant (e.g., in the case n out of n TAs need to be present, the loss of a single key share will render the election result non-computable). Reconciling the two is not an easy task. As reported by real-world experience of building E2E verifiable voting (B. Adida, O. de Marne, O. Pereira, and J.-J. Quisquater. Electing a university president using open-audit voting: Analysis of real-world use of Helios. In EVT/WOTE'09, page 10. USENIX, 2009.), the implementation of TAs has proved to be one particularly difficult issue.

One technique (F. Hao et al, “Every vote counts: Ensuring integrity in large-scale electronic voting”, USENIX Journal of Election Technology and Systems (JETS), 2(3):1-25, 2014) attempts to achieve E2E verifiability for a DRE-based election without involving any external TAs, by providing a TA-free E2E voting protocol, called Direct Recording Electronic with integrity (DRE-i). In a DRE-i system, the machine directly records the voters choice (without knowing the voter's real identity) as in the existing practice of current DRE-based elections. However, the machine is required to publish additional audit data on a public bulletin board, to enable every voter to verify the integrity of the whole voting process. In DRE-i, the encryption of a vote is based on a variant of the ElGamal encryption scheme: instead of using a fixed public key for encryption as in classic ElGamal, DRE-i uses a dynamically constructed public key for encrypting each ballot. The system removes the need for external TAs by pre-computing encrypted ballots in a structured manner such that after the election multiplication of all the published ciphertexts cancels out random factors that were introduced in the initial encryption process, and permits anyone to verify the tally.

One problem with DRE-i is that its pre-computation strategy inevitably introduces the requirement of keeping the pre-computed data secret. Leakage of those data may endanger the voter's privacy. One solution is to use tamper resistant hardware to protect the secrecy of pre-computed data for high security assurance. However, the use of tamper-resistant hardware may significantly drive up the cost for each DRE machine. Furthermore, designing secure API for tamper-resistant hardware is a challenging problem in its own. Finally, in the case that the tamper resistance is compromised, the privacy of all votes will be lost.

What is desired is a technique that can achieve strong assurance on the integrity for a DRE-based election without involving any external TAs, and simultaneously, achieve strong guarantee on the privacy of votes without depending on tamper resistant hardware.

The above information is presented as background information only to assist with an understanding of the present disclosure. No determination has been made, and no assertion is made, as to whether any of the above might be applicable as prior art with regard to the present invention.

### SUMMARY OF THE INVENTION

It is an aim of certain embodiments of the present invention to address, solve, mitigate or obviate, at least partly, at least one of the problems and/or disadvantages associated with the related art, for example at least one of the problems and/or disadvantages mentioned herein. Certain embodiments of the present invention aim to provide at least one advantage over the related art, for example at least one of the advantages mentioned herein.

The present invention is defined by the independent claims. A non-exhaustive set of advantageous features that may be used in various exemplary embodiments of the present invention are defined in the dependent claims.

In accordance with an aspect of the present invention, there is provided a method for electronic voting, the method comprising: receiving a selection of a vote vᵢ from a voter; generating one or more first values (e.g., secret values) associated with the voter; calculating one or more second values (e.g., public values) based on the one or more first values; providing a first type of receipt including the one or more second values to the voter; updating a tally, t, based on the vote vᵢ; updating a sum, s, based on the one or more first values; and publishing the receipt including the one or more second values.

In accordance with another aspect of the present invention, there is provided a system or apparatus configured for implementing a method according to any aspect, claim, embodiment or example disclosed herein. The system or apparatus may comprise a voting entity (e.g. a DRE machine) and/or a publishing entity (e.g. a bulletin board).

In accordance with another aspect of the present invention, there is provided a computer program comprising instructions arranged, when executed, to implement a method, device, apparatus and/or system in accordance with any aspect, embodiment, example or claim disclosed herein. In accordance with another aspect of the present invention, there is provided a machine-readable storage storing such a program.

Other aspects, advantages, and salient features of the present invention will become apparent to those skilled in the art from the following detailed description, which, taken in conjunction with the annexed drawings, disclose exemplary embodiments of the present invention.

### BRIEF DESCRIPTION OF THE FIGURES

FIG. 1 illustrates a system according to an exemplary embodiment of the present invention;

FIG. 2 is a flowchart of a method according to an exemplary embodiment of the present invention;

FIG. 3 illustrates one exemplary embodiment of the voting phase of the method of FIG. 2 in more detail;

FIG. 4 illustrates the bulletin board of FIG. 1 according to an exemplary embodiment in which the voting phase illustrated in FIG. 3 is used;

FIG. 5 illustrates the well-formedness dependency graph for certain parameters enforced by corresponding proofs of well-formedness;

FIGS. 6a and 6b schematically illustrate a voting phase according to exemplary embodiments;

FIG. 7 illustrates another exemplary embodiment of the voting phase of the method of FIG. 2 in more detail;

FIG. 8 illustrates the bulletin board of FIG. 1 according to an exemplary embodiment in which the voting phase illustrated in FIG. 7 is used;

FIGS. 9a and 9b schematically illustrate a voting phase according to further exemplary embodiments; and

FIG. 10 depicts the DRE-ip bulletin board.

### DETAILED DESCRIPTION OF EXEMPLARY EMBODIMENTS

The following description of exemplary embodiments of the present invention, with reference to the accompanying drawings, is provided to assist in a comprehensive understanding of the present invention, as defined by the claims. The description includes various specific details to assist in that understanding but these are to be regarded as merely exemplary. Accordingly, those of ordinary skill in the art will recognize that various changes and modifications of the embodiments described herein can be made without departing from the scope of the present invention, as defined by the claims.

The terms and words used in this specification are not limited to the bibliographical meanings, but, are merely used to enable a clear and consistent understanding of the present invention.

The same or similar components may be designated by the same or similar reference numerals, although they may be illustrated in different drawings.

Detailed descriptions of elements, features, components, structures, constructions, functions, operations, processes, characteristics, properties, integers and steps known in the art may be omitted for clarity and conciseness, and to avoid obscuring the subject matter of the present invention.

Throughout this specification, the words “comprises”, “includes”, “contains” and “has”, and variations of these words, for example “comprise” and “comprising”, means “including but not limited to”, and is not intended to (and does not) exclude other elements, features, components, structures, constructions, functions, operations, processes, characteristics, properties, integers, steps and/or groups thereof.

Throughout this specification, the singular forms “a”, “an” and “the” include plural referents unless the context dictates otherwise. For example, reference to “an object” includes reference to one or more of such objects.

By the term “substantially” it is meant that the recited characteristic, parameter or value need not be achieved exactly, but that deviations or variations, including for example, tolerances, measurement errors, measurement accuracy limitations and other factors known to those of skill in the art, may occur in amounts that do not preclude the effect the characteristic, parameter or value was intended to provide.

Throughout this specification, language in the general form of “X for Y” (where Y is some action, process, function, activity, operation or step and X is some means for carrying out that action, process, function, activity, operation or step) encompasses means X adapted, configured or arranged specifically, but not exclusively, to do Y.

Elements, features, components, structures, constructions, functions, operations, processes, characteristics, properties, integers, steps and/or groups thereof described herein in conjunction with a particular aspect, embodiment, example or claim are to be understood to be applicable to any other aspect, embodiment, example or claim disclosed herein unless incompatible therewith.

It will be appreciated that embodiments of the present invention can be realized in the form of hardware or a combination of hardware and software. Any such software may be stored in any suitable form of volatile or non-volatile storage device or medium, for example a ROM, RAM, memory chip, integrated circuit, or an optically or magnetically readable medium (e.g. CD, DVD, magnetic disk or magnetic tape). It will also be appreciated that storage devices and media are embodiments of machine-readable storage that are suitable for storing a program or programs comprising instructions that, when executed, implement embodiments of the present invention.

A DRE voting system may be implemented by a machine (DRE) that stores, updates, and reports the tally for an election. That is, during the voting phase for each voter the DRE acquires their vote and accordingly updates the tally that it keeps, and at the end of the election the DRE simply reports the tally. Such a system, which may be referred to as DRE voting, is a non-verifiable system in which the voters simply have to trust DRE machines as black-boxes.

DRE-i improves on DRE voting by adding a mechanism for end-to-end verifiability. To do so, DRE-i requires a publicly accessible and append-only bulletin board (BB) on which the DRE machines post audit information to enable individual and universal verifiability. The tally posted by the DRE machine at the end of the election can be verified directly against the audit information on the bulletin board and hence DRE-i does not require tallying authorities. To achieve this, DRE-i requires that all the possible ballots for the entire election are pre-computed so that a certain algebraic equation is satisfied.

However, the pre-computation approach of DRE-i naturally requires that the pre-computed ballots are kept secret. This may be achieved using a tamper resistant hardware to improve the data protection, but with a drawback of higher cost. Furthermore, the assurance on tamper resistant hardware can never be absolute. In the case that the tamper resistant hardware is compromised, the privacy of all votes will be lost.

Embodiments of the present invention provide an E2E verifiable voting system, referred to herein as DRE-ip (DRE-i with enhanced privacy). In embodiments of the present invention, instead of pre-computing ciphertexts before the election, each vote is encrypted on the fly (i.e. in real-time) during voting. This may be achieved by applying certain novel cryptographic algorithms, which will be described in greater detail below.

Accordingly, embodiments of the present invention may achieve E2E verifiability without requiring TAs, and at the same time provide significantly stronger privacy guarantee than DRE-i. Since ballot information does not need to be pre-computed in advance, tamper resistant hardware is not required to store that information.

Embodiments of the present invention provide the same end-to-end verifiability as DRE-i, including mechanisms for individual verification that the ballots are cast as intended and recorded as cast, and for public verification that the ballots are tallied as recorded. Furthermore, in relation to privacy, embodiments of the present invention provide indistinguishability of elections with the same tally, against non-intrusive attacks based on the Decision Diffe-Hellman assumption, discussed below. In addition, in embodiments of the present invention, in the event of an intrusive attack that fully compromises the DRE machines, only the privacy of the ballots cast during the attack period may be lost, and the ballots cast outside the attack period remain private under the Square Decision Diffie-Hellman assumption, discussed below. This provides a much stronger privacy guarantee than DRE-i, where an intrusive attack can reveal the privacy of all ballots.

In the following, the notation P_{K}{l:G=g^{l}} is used to denote a non-interactive proof of knowledge of (a secret) l such that (for publicly-known G and g): G=g^{l}. Where the context is clear, the notation may be shortened to P_{K}{l}. Also, the notation P_{WF}{A:X,Y,Z} is used to denote a proof of well-formedness of A with respect to X, Y and Z. Where the context is clear, the notation may be shortened to P_{WF}{A}.

Zero knowledge proofs are techniques that prove the truth of a statement without revealing any other information. Proofs of knowledge, intuitively speaking, are proofs that are guaranteed to be generated by a prover with explicit knowledge of a specific quantity.

An interactive proof is a proof made by a party “prover” to another party “verifier” which requires several rounds of exchanging messages between the two parties. A non-interactive proof is a proof not requiring multiple rounds. In such a proof, the prover sends one message, the non-interactive proof, to the verifier and the verifier can check the validity of the proof on its own. A non-interactive proof of knowledge is a proof of knowledge which is non-interactive.

Well-formedness refers to state of a value being calculated according to the specified protocol. A proof of well-formedness is a message from a prover that shows to a verifier that a particular value has been calculated according to an agreed protocol.

In the following embodiments, Schnorr proofs of knowledge of discrete logarithm (C. P. Schnorr, “Efficient signature generation by smart cards”, Journal of cryptology, 4(3):161-174, 1991) are used, and certain techniques (R. Cramer et al, “Proofs of partial knowledge and simplified design of witness hiding protocols”, Advances In Cryptology—CRYPTO '94, volume 839 of LNCS, pages 174-187, 1994) are applied to construct proofs of disjunctive or conjunctive knowledge. A Fiat-Shamir heuristic may then be applied to make the proofs non-interactive (A. Fiat et al, “How to prove yourself: Practical solutions to identification and signature problems”, Advances in Cryptology—CRYPTO '86, volume 263 of LNCS, pages 186-194, 1987). As a result of this last transformation, the following embodiments are in the Random Oracle Model (M. Bellare et al., “Random oracles are practical: A paradigm for designing efficient protocols, ACM Conference on Computer and Communications Security, CCS '93, pages 62-73, 1993). However, the skilled person will appreciate that any other suitable techniques may be applied in alternative embodiments.

In the following example, a DSA-like multiplicative cycle group setting is assumed, where p and q are large primes that satisfy q|p−1, and the subgroup [symbol] _{q} of order q of the group [symbol] *ₚ is used. The protocol can be implemented over elliptic curves, i.e., in an ECDSA-like group, or any other setting where the DDH and Square DDH assumptions hold. [symbol] _{q} denotes a subgroup (in the sense of group theory) of size q, that is a group of q elements between which an operation, in this case multiplication, is defined. [symbol] *ₚ denotes the group of integers smaller than p not including zero, that is, the set {1, 2, 3, . . . , p−1}. a|b denotes that a divides b, i.e., a is a divisor of b, or in other words, b is a multiple of a. DSA, or the Digital Signature Algorithm, is a standard for producing and verifying digital signatures and is a variant of the ElGamal signature. It is adopted as the FIPS 186 standard and is covered by U.S. Pat. No. 5,231,668. ECDSA, or the Elliptic Curve Digital Signature Algorithm, is a variant of the Digital Signature Algorithm (DSA) which is implemented using elliptic curve cryptography.

The decision Diffie-Hellman (DDH) assumption is defined as follows. For a generator g and randomly chosen a, b , [symbol] _{q} and R , [symbol] _{q}, given (g,g^{a},g^{b},W) where W , {g^{ab},R}, it is hard to decide whether W=g^{ab} or W=R. Here, the term ‘hard’ may be understood as meaning computationally hard within the context of computational complexity theory.

The Square DDH assumption is defined as follows. For a generator g and randomly chosen a , [symbol] ^{*}_{q} and R , [symbol] _{q}, given (g,g^{a},W) where W , {W^{â2},R}, it is hard to decide whether W=g^{â2} or W=R. Here, the term ‘hard’ may be understood as having the same meaning as above, and the notation “A” means “to the power of”.

The skilled person will appreciate that if the DDH assumption can be broken, then the Square DDH assumption can be broken as well. Hence, Square DDH is a stronger assumption that and implies DDH. Furthermore, there is evidence that Square DDH is strictly stronger.

The following embodiments are described in relation to a voting system for the binary case where there are only two candidates to choose from, i.e., for vᵢ representing the vote of the i-th ballot, vᵢ, {0,1}. However, the skilled person will appreciate that other embodiments may support more than two candidates. For example, the binary case may be extended to more than two candidates by applying any suitable technique, for example techniques described in O. Baudron et al, “Practical multi-candidate election system”, ACM Symposium on Principles of Distributed Computing, PODC '01, pages 274-283, ACM 2001 or F. Hao et al, “Every vote counts: Ensuring integrity in large-scale electronic voting”, USENIX Journal of Election Technology and Systems (JETS), 2(3):1-25, 2014.

A verifiable e-voting scheme without tallying authorities is described in Siamak F. Shahandashti and Feng Hao, “DRE-ip: A Verifiable E-Voting Scheme without Tallying Authorities”, which may be accessed via https://eprint.iacr.org/2016/670.pdf. This paper is a full version of a paper of the same title appearing in ESORICS 2016, and is referred to below and included herein as an “Annex” to this description. Another verifiable e-voting scheme without tallying authorities is described in Siamak F. Shahandashti and Feng Hao, “DRE-ip: A Verifiable E-Voting Scheme without Tallying Authorities”, which may be accessed via https://eprint.iacr.org/eprint-bin/getfile.pl?entry=2016/670&version=20160704:074258&file=670.pdf. The entire contents of each of the foregoing documents are also incorporated herein by reference. The skilled person will appreciate that any of the techniques and details described in said Annex may be applied in any suitable combination to the embodiments described herein, for example either by replacing one or more features of the embodiments described herein or adding to the embodiments described herein.

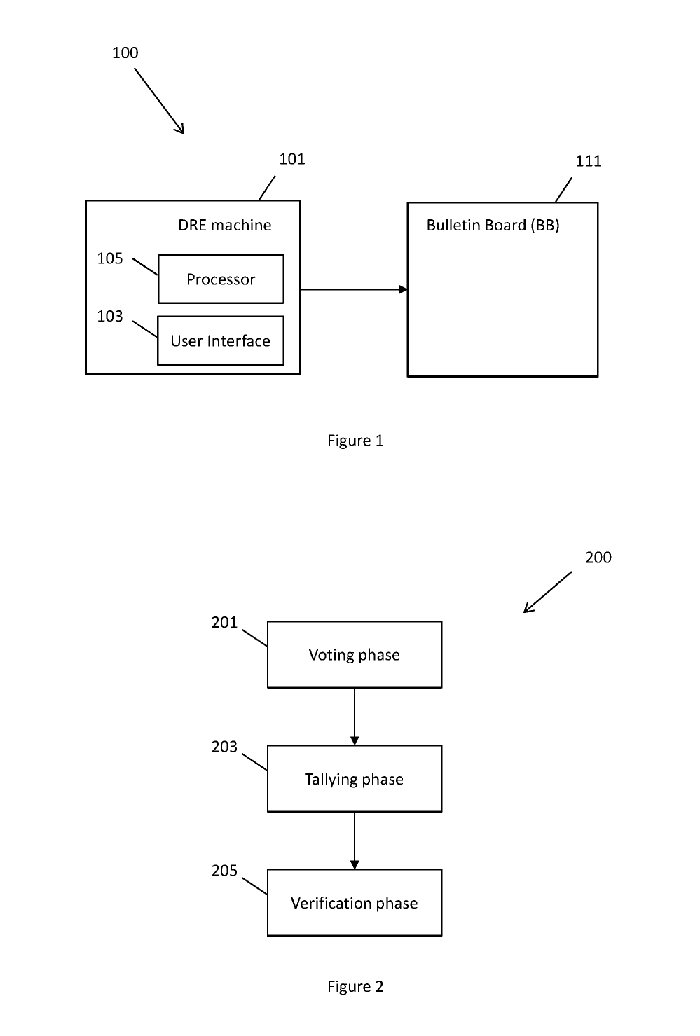

FIG. 1 illustrates a system 100 according to an exemplary embodiment of the present invention. The system comprises a voting entity (e.g. a direct-recording electronic (DRE) machine) 101 for allowing a voter to electronically record a vote, and a publishing entity for publishing information (e.g. a bulletin board (BB)) 111 for allowing individual votes and/or the vote tally to be verified. The term “voter” may be used herein to refer to either an actual voter participating in an election, or to any other relevant party who wishes to verify the validity of one or more of the votes cast and/or verify the validity of the vote tally (e.g. an election monitor or observer). In the latter case, the party may or may not be participating as an actual voter in the election.

The DRE 101 comprises a user interface 103 for receiving a user's vote. The user interface 103 may be provided in any suitable form, for example a touch screen, allowing a vote to select a candidate from among two or more candidates. The DRE 101 also comprises a processor 105 for controlling operation of the DRE 101, for performing certain operations, and for providing certain information to the BB 111, as described in greater detail below. The DRE 101 may be provided in the form of a physical machine, device or apparatus, for example a device provided at a polling booth. Alternatively, the DRE 101 may be provided so as to allow a voter to cast a vote remotely. For example, the DRE 101 may be implemented in the form of a secure server that provides a voting webpage accessible from a computer.

The BB 111 may comprise any suitable entity for recording certain information provided by the DRE, and for displaying certain information to any party who wishes to verify the validity of one or more of the votes cast and/or verify the validity of the vote tally (e.g. the public or election monitoring parties). For example, the BB 111 may be implemented by a secure server that publishes information through a publicly accessible web page. The operation of the BB 111 is described in greater detail below.

Embodiments of the present invention employ a secure and publicly-accessible bulletin board and incorporate voter-initiated auditing to achieve end-to-end verifiability. In the exemplary embodiment of FIG. 1, it is assumed that DRE has append-only write access to BB over an authenticated channel. It is also assumed that secure voter registration and authentication procedures are in place. At the time of voting, a voter is authenticated first and issued a token, unlinked to their identity. When casting a vote (e.g. in a voting booth), the voter may authenticate themself by providing the DRE with the token. The skilled person will appreciate that the present invention is not limited to the specific configuration described above.

In the following embodiments, a setup procedure (e.g. performed by the DRE) establishes two generators (values) g and ĝ as public parameters of the system. The logarithm relation between g and ĝ is unknown to an outside entity (e.g. an entity other than one trusted to maintain the secrecy of the vote). In one exemplary embodiment, DRE generates ĝ=g^{r} from a randomly chosen r, and deletes r immediately after this operation. DRE keeps track of the running tally t=s vᵢ for the cast votes vᵢ, and s=s xᵢyᵢ for random xᵢ and yᵢ generated on the fly. Herein, ĝ may also be denoted \tilde{g}, X~ may also be denoted \tilde{X}, and \hat{Z} may also be denoted \tilde{Z}.

To achieve individual verifiability, embodiments of the present invention incorporate voter-initiated auditing in which the voter gets the option to audit the ballot composed by the DRE to gain confidence that the DRE is preparing the ballots according to their choice. If a ballot is audited, it cannot be used to cast a vote. Therefore, the set of all ballots [symbol] at the closing of the voting phase will be comprised of the audited ballots [symbol] and the cast ballots [symbol] , i.e., [symbol] = [symbol] ″ [symbol] .

In brief, when a party (e.g. a voter) inputs a vote selection to the DRE machine, the DRE machine creates a ballot, which the voter can choose to either cast or audit. If the ballot is audited then the process is repeated, otherwise the ballot is cast. The auditing phase (comprising one or more auditing rounds) allows the voter to check that the DRE is correctly recording the voter's voting selections.

The DRE machine may be compromised and may attempt to alter the voter's voting selections. In this case, to avoid detection of the compromise (i.e. alteration of the voter's voting selections), the compromised DRE machine would need to correctly record the voter's voting selections in every one of the auditing rounds. However, the DRE machine does not know how many auditing rounds will take place (this is decided by the voter), and therefore does not know in which round the ballot is actually cast. Therefore, if the compromised DRE machine attempts to alter the voter's voting selection in the actually cast ballot (e.g. by trying to guess which round the ballot is actually cast), there is a non-zero probability that the DRE machine will alter the voter's voting selection in one or more of the auditing rounds, and hence the compromise will be detected. Although there is a chance that comprise of the DRE machine will go undetected in a single vote, the probability that compromise of the DRE machine will go undetected becomes very small with increasing number of votes.

In practice, a normal voter may decide to simply cast their vote without auditing, whereas an election monitor or observer may perform auditing. The amount of auditing performed may be chosen to ensure that the probability that compromise of the DRE machine goes undetected is below a certain threshold (e.g. essentially zero). For example, if 5% of the ballots are audited then the probability that compromise of the DRE machine goes undetected is very low.

As will be described below, certain information relating to the audited and cast ballots is published so that, once the voting phase has been completed, the result of the voting phase (e.g. the vote tally) can be verified by any interested party. For example, receipts of each audited and cast ballot, each provided with a unique identifier, are published on a publicly accessible bulletin board. An individual voter may compare their own receipts received from the DRE machine during voting with the corresponding receipts posted on the bulletin board to check that their vote has been cast. Furthermore, the vote tally may be verified based on information provided on the published receipts using a public algorithm, as described below.

FIG. 2 is a flowchart of a method according to an exemplary embodiment of the present invention. The method 200 comprises a voting phase 201, followed by a tallying phase 203, followed by a verification phase 205.

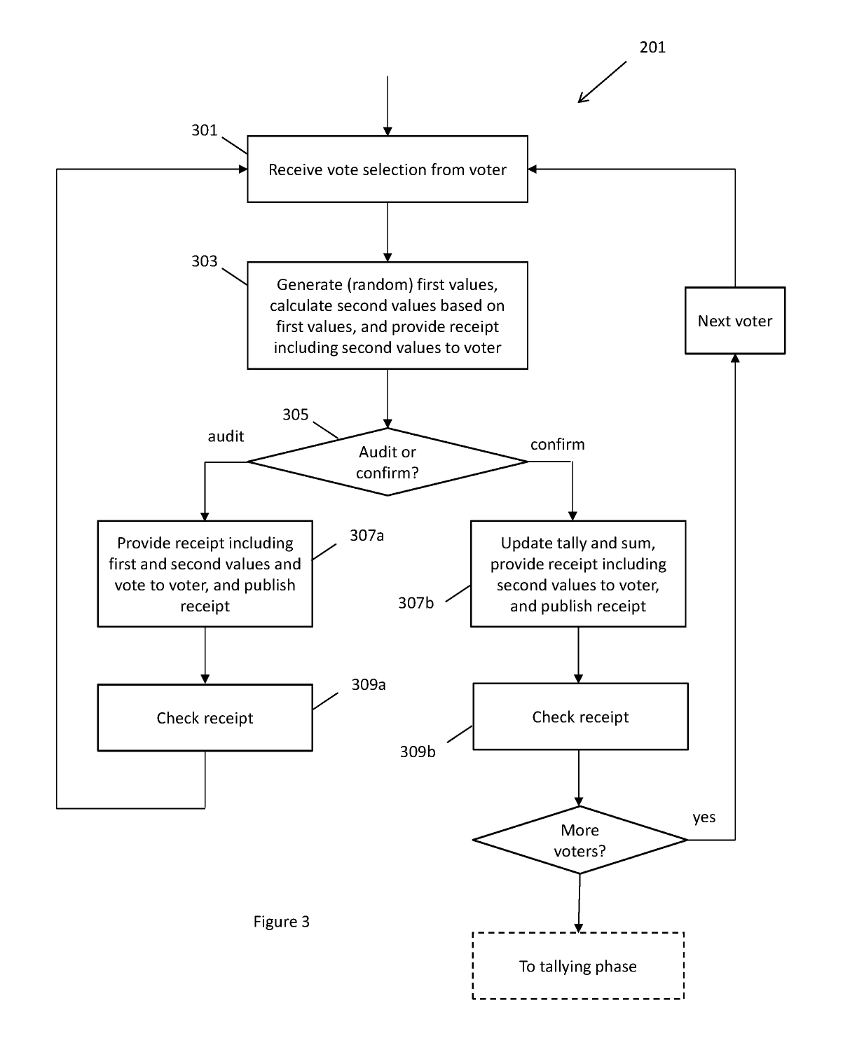

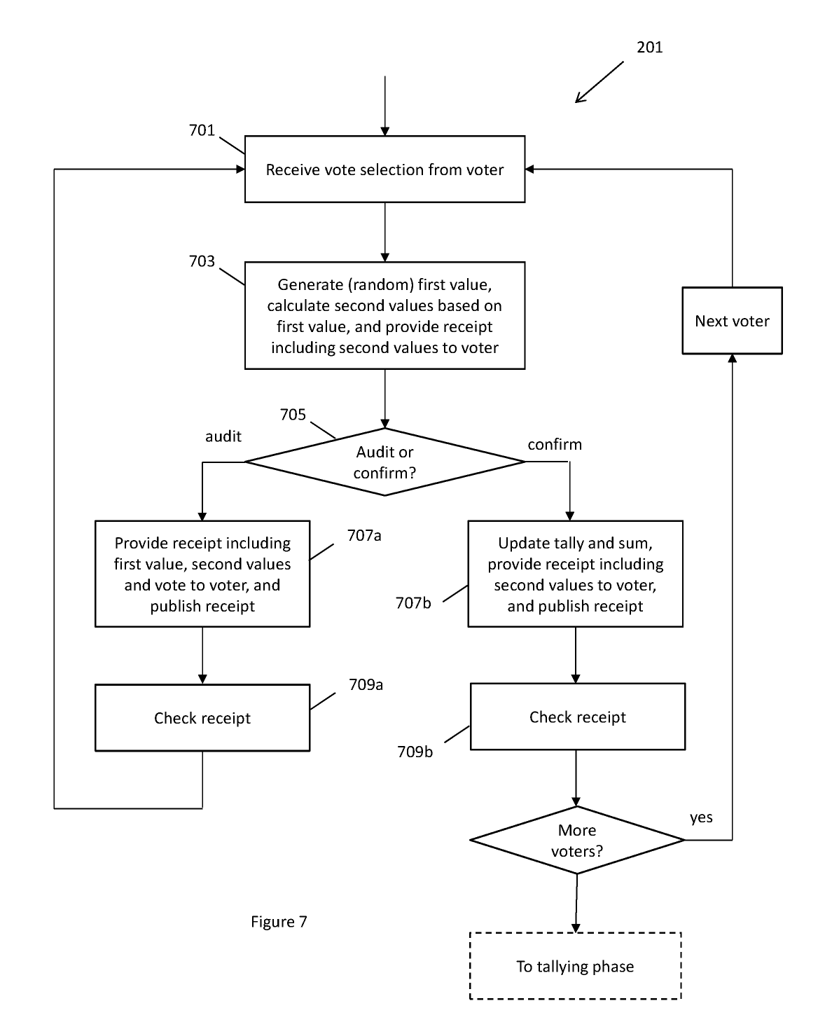

One exemplary embodiment of the voting phase 201 of the method of FIG. 2 is illustrated in more detail in FIG. 3. Another exemplary embodiment of the voting phase 201 of the method of FIG. 2 is illustrated in more detail in FIG. 7.

The voting phase involves the voter, the DRE, and the BB. In relation to the embodiment illustrated in FIG. 3, in a first step 301, the voter initiates voting, and keys in their vote vᵢ,{0,1}. In a second step 303, the DRE (i.e. the processor of the DRE) generates first values comprising random values xᵢ, yᵢ, [symbol] *_{q}, and calculates second values comprising the following:

Xᵢ=g^{x}^{ᵢ}

Yᵢ=g^{y}^{ᵢ}

\tilde{X}ᵢ=\tilde{g}^{x}^{ᵢ}

P_{WF}{\tilde{X}ᵢ:g,Xᵢ,\tilde{g}}

Zᵢ=g^{x}^{ᵢ}^{y}^{ᵢ}g^{v}^{ᵢ}

P_{WF}{Zᵢ:g,Xᵢ,Yᵢ}

\tilde{Z}ᵢ=\tilde{g}^{x}^{ᵢ}^{y}^{ᵢ}

P_{WF}{\tilde{Z}ᵢ:g,Xᵢ,\tilde{Y}ᵢ}

In step 303, the DRE may provide a signed receipt including the ballot (or voter) index i, and the second values Xᵢ, Yᵢ, X~ᵢ, P_{WF}{X~ᵢ}, Zᵢ, P_{WF}{Zᵢ}, \hat{Z}ᵢ and P_{WF}{\hat{Z}ᵢ} to the voter.

In the above, the first values xᵢ and yᵢ are values (e.g. random secret values) generated per voter. In certain embodiments, these values may have a length between 256 bits and 256 bytes, for example. These values remain secret. On the other hand, the values g and g are fixed for all voters. These values are made public, for example before the election. In one embodiment, g and g may be two generators selected at random in the considered cryptographic group whose discrete logarithm relation is unknown. In an alternative embodiment, g may be a fixed generator and ĝ is computed as ĝ=g^{r} where r is a random value and is deleted, for example immediately after the computation.

In a third step 305, the voter observes that the receipt is provided, and chooses to either audit the ballot or confirm their vote.

In a fourth step 307, the DRE performs an operation depending on whether the vote is audited or confirmed.

In the case of audit, in step 307a, the DRE adds i to [symbol] , and provides a signed receipt of audit (which may be marked “audited” for example) including the first values xᵢ, yᵢ and the vote value vᵢ to the voter. As described further below, in step 309a, the DRE also prompts the voter to check or verify if vᵢ correctly reflects the voter's intended choice. If the checking or verification succeeds (i.e. if the vote value vᵢ included on the receipt correctly reflects the voter's intended choice), the method continues to the first step 301. If the checking or verification does not succeed, the voter may raise a dispute.

In certain embodiments, the receipt generated in step 303 and the receipt generated in step 307a may be issued to the voter as two separate receipts in steps 303 and 307a, respectively. Alternatively, the receipt generated in step 303 may be issued to the voter in step 303, and a combined receipt comprising the receipt generated in step 303 and the receipt generated in step 307a may be issued to the voter in step 307a.

In the case of confirmation 307b, the DRE adds i to [symbol] , updates the tally and the sum

$$t = {\sum }_{j ∈ ℂ} {v}_{j}$$

$$s = {\sum }_{j ∈ ℂ} {x}_{j} {y}_{j}$$

provides a receipt of confirmation (which may be marked “confirmed” for example) to the voter, securely deletes xᵢ, yᵢ and vᵢ, and posts on BB all the receipts provided to the voter.

In certain embodiments, the receipt generated in step 303 and the receipt generated in step 307b may be issued to the voter as two separate receipts in steps 303 and 307b. Alternatively, the receipt generated in step 303 may be issued to the voter in step 303, and a combined receipt comprising the receipt generated in step 303 and the receipt generated in step 307b may be issued to the voter in step 307b.

A receipt may be provided in any suitable form. For example, a receipt may be provided as a physical item (e.g. a piece of paper). The authenticity of the receipt from the DRE machine needs to be guaranteed. In one embodiment, the machine digitally signs the receipt using any suitable technique, numerous examples of which will readily occur to the skilled person. In another embodiment, the receipt may be printed on special security paper.

In the above, the running tally t (other than the final tally) and the sum s are kept secret.

In a fifth step 309a, 309b, the voter checks that their receipts exactly match those appearing on BB, and that the votes vᵢ on their audited receipts reflect her actual choices. In the case a vote is confirmed and steps 307a and 307b are performed, voting is completed for that voter.

As illustrated in FIG. 3, if there are more voters, the process may be repeated for each voter, otherwise the method proceeds to the tallying phase 203.

In some embodiments, all receipts (including the confirmed receipt and previous audited receipts) for a certain voter may be posted on the BB all at once when that voter has confirmed their vote. Alternatively, receipts may be posted on the BB one by one (or in groups) as and when they are provided during the above-described process.

Similarly, in some embodiments, a certain voter may check all their receipts (including the confirmed receipt and previous audited receipts) all at once when that voter has confirmed their vote. Alternatively, the voter may check their receipts one by one (or in groups) as and when they are provided during the above-described process.

The DRE may post a receipt on the BB by providing (e.g. transmitting) the receipt to the BB. Upon receiving the receipt, the BB makes the receipt available to any party who wishes to verify the validity of one or more of the votes cast and/or verify the validity of the vote tally. Herein, references to publishing a receipt or positing a receipt may refer to the operation of the DRE providing the receipt to the BB, the operation of the BB making the receipt available, or both.

The tallying phase 203 of the method of FIG. 2 involves the DRE, the BB and the public.

In relation to the embodiment described above in relation to FIG. 3, in the tallying phase 203, the DRE calculates

$$S = {g}^{s}$$

$${P}_{WF} \{ S \text{:} g , \tilde{g} , {\prod }_{j ∈ ℂ} {\tilde{Z}}_{j} \}$$

and posts on BB the final tally t, as well as S and P_{WF}{S}.

In the verification phase 205 of the method of FIG. 2, any party (e.g. the public or an election monitor) may verify the validity of all the well-formedness proofs on BB (well-formedness verification), verify that for all the audited ballots on BB, Xᵢ, Yᵢ, X~ᵢ, Zᵢ and \hat{Z}ᵢ included in the first part of the receipt are consistent with xᵢ, yᵢ and vᵢ included in the second part (and with the system parameters g and ĝ) (audit consistency verification), and verify that the following equation holds (tally verification):

$${\prod }_{j ∈ ℂ} {Z}_{j} = {Sg}^{t}$$

The various proofs of well-formedness P_{WF} may be checked to verify that all of the other values have been correctly computed according to the protocol.

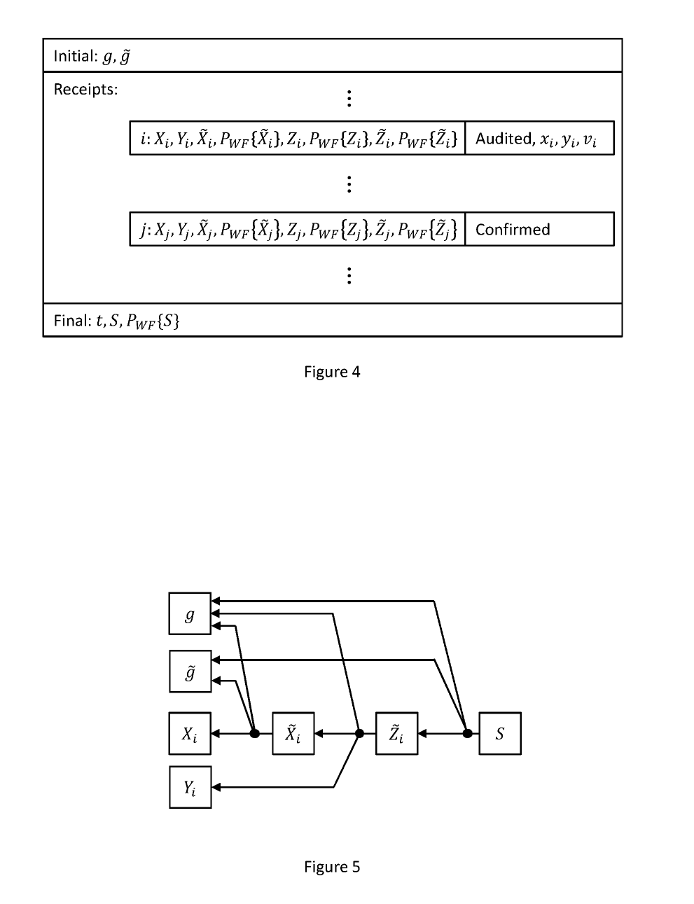

FIG. 4 illustrates the BB of FIG. 1 according to an exemplary embodiment in which the method described above in relation to FIG. 3 is used. In FIG. 4, an audited receipt (with index i) and a confirmed receipt (with index j) are shown. Each receipt has two parts: the first part may be provided to the voter before the user decides to either audit or confirm the ballot and includes at least some of the same information for all receipts; the second part is provided after the voter makes their decision and includes at least some different information based on the voter's choice. Both parts of the receipt may be signed by DRE.

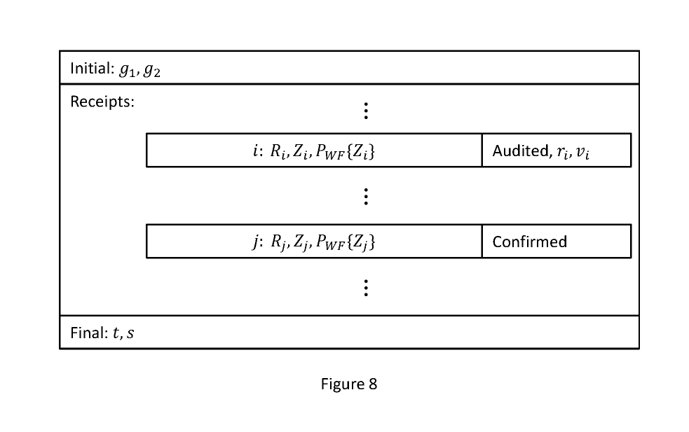

Another exemplary embodiment of the voting phase 201 of the method of FIG. 2 will now be described with reference to FIGS. 7 and 8. As certain details of this embodiment are the same as the embodiment described above in relation to FIGS. 3 and 4, some details may be omitted from the following description for reasons of conciseness.

The voting phase involves the voter, the DRE, and the BB. In relation to the embodiment illustrated in FIG. 7, in a first step 701, the voter initiates voting, and keys in their vote vᵢ {0,1}. In a second step 703, the DRE (i.e. the processor of the DRE) generates a first value comprising a random value rⱼ, , [symbol] *_{q}, and calculates second values comprising the following:

$${R}_{i} = {g}_{2}^{{r}_{i}}$$

$${Z}_{i} = {g}_{1}^{{r}_{i}} {g}_{1}^{{v}_{i}}$$

$${P}_{WF} \{ {Z}_{i} \text{:} {g}_{1} , {g}_{2} , {R}_{i} \}$$

In step 703, the DRE may provide a signed receipt including the ballot (or voter) index i, and the second values Rᵢ, Zᵢ and P_{WF}{Zᵢ} to the voter.

In the above, the first value rᵢ is a value (e.g. a random value) generated per voter that remains secret. In certain embodiments, this value may have a length between 256 bits and 256 bytes, for example. On the other hand, the values g₁ and g₂ are fixed for all voters, and are made public, for example before the election. In one embodiment, g₁ and g₂ may be two generators selected at random in the considered cryptographic group whose discrete logarithm relation is unknown. In an alternative embodiment, g₁ may be a fixed generator and g₂ is computed as g₂=g₁^{r} where r is a random value and is deleted, for example immediately after the computation.

In a third step 705, the voter observes that the receipt is provided, and chooses to either audit the ballot or confirm their vote.

In a fourth step 707, the DRE performs an operation depending on whether the vote is audited or confirmed.

In the case of audit, in step 707a, the DRE adds i to [symbol] , and provides a signed receipt of audit (which may be marked “audited” for example) including the first value rᵢ and the vote value vᵢ to the voter. Similar to the embodiment of FIG. 3, in step 709a, if it is verified that vᵢ correctly reflects the voters intended choice, the method continues to the first step 701, but if not, the voter may raise a dispute.

In the case of confirmation 707b, the DRE adds i to [symbol] , updates the tally and the sum:

$$t = {\sum }_{j ∈ ℂ} {v}_{j}$$

$$s = {\sum }_{j ∈ ℂ} {r}_{j}$$

provides a receipt of confirmation (which may be marked “confirmed” for example) to the voter, securely deletes rᵢ and vᵢ, and posts on BB all the receipts provided to the voter. In the above, the running tally t (other than the final tally) and the sum s are kept secret.

In a fifth step 709a, 709b, the voter checks that their receipts exactly match those appearing on BB, and that the votes vᵢ on their audited receipts reflect her actual choices. In the case a vote is confirmed and steps 707a and 707b are performed, voting is completed for that voter.

If there are more voters, the process may be repeated for each voter, otherwise the method proceeds to the tallying phase 203.

In certain embodiments, the features relating to the receipts (e.g. the form of the receipts, the signing of the receipts, the time at which the receipts are provided to the voter, the time at which the receipts are posted on the BB, the manner in which the receipts are posted on the BB, and/or the time at which the receipts are checked by the voter) may be the same for the embodiments of FIGS. 3 and 7.

The tallying phase 203 involves the DRE, the BB and the public. In relation to the embodiment described above in relation to FIG. 7, in the tallying phase 203, the DRE posts on BB the final tally t and the final sum s.

In relation to the embodiment described above in relation to FIG. 7, in the verification phase 205 of the method of FIG. 2, any party (e.g. the public or an election monitor) may verify the validity of all the well-formedness proofs on BB (well-formedness verification), verify that for all the audited ballots on BB, Rᵢ and Zᵢ included in the first part of the receipt are consistent with rᵢ and vᵢ included in the second part (and with the system parameters g₁ and g₂) (audit consistency verification), and verify that the following equations hold (tally verification):

$${\prod }_{j ∈ ℂ} {R}_{j} = {g}_{2}^{s}$$

$${\prod }_{j ∈ ℂ} {Z}_{j} = {g}_{1}^{s} {g}_{1}^{t}$$

The various proofs of well-formedness P_{WF} may be checked to verify that all of the other values have been correctly computed according to the protocol.

FIG. 8 illustrates the BB of FIG. 1 according an exemplary embodiment in which the method described above in relation to FIG. 7 is used. The receipts (audited and confirmed) of FIG. 8 correspond to the receipts of FIG. 3, and therefore a detailed description thereof is omitted for conciseness.

In certain exemplary embodiments, a hash function (e.g. truncated hash function), or any other suitable one-way function, may be used to calculate a digest (e.g. 20 alphanumeric characters long) of a receipt or one or more parts of a receipt. These digests may be provided on the receipts provided to the voter and may be posted on the BB. In this case, rather than directly compare the values provided on a receipt with the corresponding values posted on the BB, the corresponding digests may be compared instead to facilitate the comparison.

In certain scenarios, the voters may be expected to verify their receipts before leaving the polling station. Facilities may be provided for them to do so in the polling station.

In the embodiments described above in relation to FIGS. 1-4, 7 and 8, well-formedness verification, audit consistency verification, and tally verification are all performed. However, the skilled person will appreciate that in certain alternative embodiments, if one or more of these verification processes are not required or not used, then one or more of the second values (e.g. Xᵢ, Yᵢ, X~ᵢ, P_{WF}{X~ᵢ}, Zᵢ, P_{WF}{Zᵢ}, \hat{Z}ᵢ and P_{WF}{\hat{Z}ᵢ} as described in relation to FIG. 3, or Rᵢ, Zᵢ and P_{WF}{Zᵢ} as described in relation to FIG. 7) may be omitted from the above-described process, depending on which verification operations are used and which are not.

In the above-described embodiment, a confirmed ballot may be preceded by one or more (or possibly zero) audited ballots. However, in some embodiments, one or more parties (e.g. election monitors or observers) may audit one or more ballots, but not confirm any ballot (e.g. if they are not participating in the actual election). In this case, the party may choose to audit a chosen number of ballots (i.e. steps 301, 303, 305, 307a and 309a of FIG. 3, or steps 701, 703, 705, 707a and 709a of FIG. 7, are repeated a chosen number of times) before the method moves to the next voter (or other relevant party), if any.

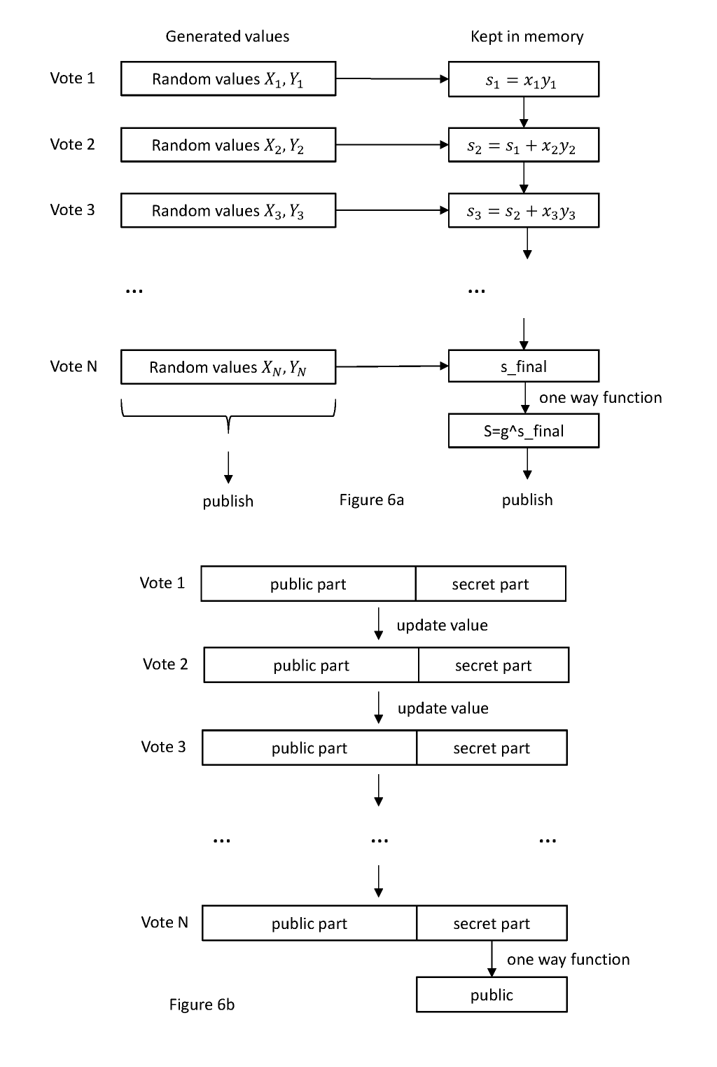

FIGS. 6a and 6b schematically illustrate the technique described above in relation to FIG. 3, in particular with respect to updating the sum s and calculating the value S, and a generalised case.

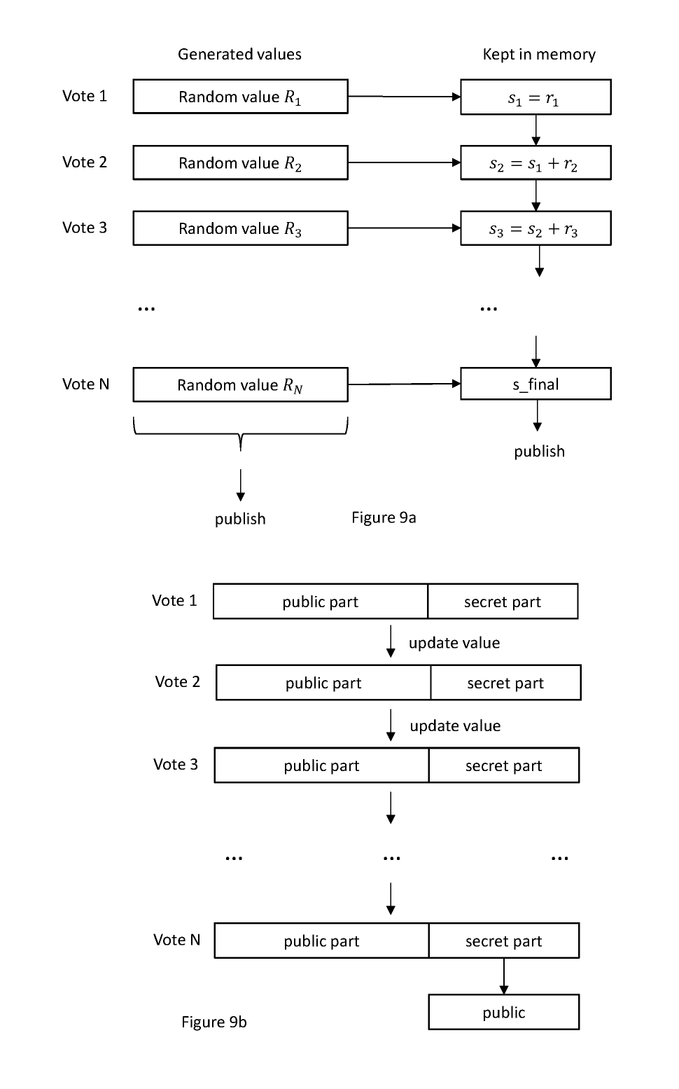

FIGS. 9a and 9b schematically illustrate the technique described above in relation to FIG. 7, in particular with respect to updating the sum s, and a generalised case.

In relation to the embodiment of FIG. 3, the proofs of well-formedness are realised as follow. P_{WF}{X~ᵢ:g,Xᵢ,ĝ}, P_{WF}{\hat{Z}ᵢ:g,YᵢX~ᵢ}, and P_{WF}{S:g,ĝ,j , [symbol] \hat{Z}ⱼ} are all realised as proofs of knowledge and equality of two discrete logarithms as follows.

$${P}_{WF} \{ {\tilde{X}}_{i} \} = {P}_{K} \{ {x}_{i} \text{:} {X}_{i} = {g}^{{x}_{i}} {\tilde{X}}_{i} = {\tilde{g}}^{{x}_{i}} \}$$

$${P}_{WF} ( {\tilde{Z}}_{i} \} = {P}_{K} \{ {y}_{i} \text{:} {Y}_{i} = {g}^{{y}_{i}} {\tilde{Z}}_{i} = {\tilde{X}}_{i}^{{y}_{i}} \}$$

$${P}_{WF} \{ S \} = {P}_{K} \{ s \text{:} S = {g}^{s} {\prod }_{j ∈ ℂ} {\tilde{Z}}_{j} = {\tilde{g}}^{s} \}$$

P_{WF}{Zᵢ:g,Xᵢ,Yᵢ} is realised as a proof of knowledge

$${P}_{WF} \{ {Z}_{i} \} = {P}_{K} \{ {x}_{i} \text{:} ( {X}_{i} = {g}^{{x}_{i}} {Z}_{i} = {Y}_{i}^{{x}_{i}} ) ( {X}_{i} = {g}^{{x}_{i}} \frac{{Z}_{i}}{g} = {Y}_{i}^{{x}_{i}} ) \}$$

The proof guarantees that Z is equal to g^{xiyi} or g^{xiyi}g, i.e. vᵢ is either zero or one.

Here, symbols v and A denote logical OR and AND respectively. For example, (Statement 1 v Statement 2) means that at least one of Statement 1 and Statement 2 is correct, whereas (Statement 1 [symbol] Statement 2) means that both Statement 1 and Statement 2 are correct.

In relation to the embodiment of FIG. 7, the proof of well-formedness P_{WF}{Zᵢ:g₁,g₂,Rᵢ} can be implemented as a non-interactive proof of knowledge

$${P}_{WF} \{ {Z}_{i} \} = {P}_{K} \{ {r}_{i} \text{:} ( {R}_{i} = {g}_{2}^{{r}_{i}} {Z}_{i} = {g}_{1}^{{r}_{i}} ) ( {R}_{i} = {g}_{2}^{{r}_{i}} \frac{{Z}_{i}}{{g}_{1}} = {g}_{1}^{{r}_{i}} ) \}$$

This proof guarantees that Zᵢ, {g₁^{r}^{ᵢ},g₁^{r}^{ᵢ}g₁}, or equivalently vᵢ, {0,1}.

The well-formedness proofs used in the above-described exemplary embodiment are based on Schnorr proofs of knowledge of discrete logarithm. Starting with a Schnorr proof, certain techniques may be applied to construct proofs of disjunctive knowledge, conjunctive knowledge, and combinations of both. A Fiat-Shamir heuristic may then be applied to make the constructed proofs non-interactive. The proof needs to be bound to the prover to prevent replay attacks. In one embodiment, the unique identifier of the entity generating the proof is embedded in the proof. The skilled person will appreciate that any other suitable type of well-formedness proofs may be used in alternative embodiments.

In the above embodiment, the voting procedure includes the case where a voter does indeed vote. The receipts are posted on BB only if the voter confirms her final vote. In certain embodiments, a procedure may be in place to ensure that if the voter cancels the voting procedure at any step, all the receipts issued up to the time of cancellation are posted on BB by DRE.

Furthermore, in the above embodiment, the voting procedure includes the case that there are only two candidates. However, in certain embodiments, the voting procedure may be extended to support more than two candidates, for example voting for 1 out of n candidates for n≧3.

For example, one technique is to run a separate parallel DRE-ip system for each candidate. Let vᵢⱼ represent the vote in ballot i and candidate j. 1 out of n votes for n≧3 can then be captured as a vᵢⱼ=1 vote for one candidate and vᵢⱼ=0 votes for all other candidates. If only one candidate is allowed to be selected, an extra proof of well-formedness is required to guarantee that only one of the votes vᵢⱼ over all values of j is 1.

In relation to the embodiment of FIG. 3, since for each j the well-formedness proof P_{WF}{Zᵢⱼ} already guarantees that vᵢⱼ∈{0,1}, it would be sufficient for the extra proof to only show that Σⱼvᵢⱼ=1. Given the values \tilde{Z}ᵢⱼ, this proof could be constructed as the proof of knowledge

$${P}_{K} \{ {σ}_{i} \text{:} ( {\prod }_{j} {Z}_{ij} ) / g = {g}^{{σ}_{i}} {\prod }_{j} {\tilde{Z}}_{ij} = {\tilde{g}}^{{σ}_{i}} \}$$

Where σᵢ=Σⱼxᵢⱼyᵢⱼ.

In relation to the embodiment of FIG. 7, The i-th ballot will be of the form of a (3n+1)-tuple: ((Rᵢⱼ,Zᵢⱼ,P_{WF}{Zᵢⱼ})ⁿⱼ₌₁,p), where p represents the extra proof. Since for each j the well-formedness proof P_{WF}{Zᵢⱼ} already guarantees that vᵢⱼ , {0,1}, it would be sufficient for the extra proof to only show that sⁿⱼ₌₁vᵢⱼ=1. Given the values Rᵢⱼ=g₂^{rij}, this proof may be constructed as the proof of knowledge

P_{K}{σᵢ:(ΠⱼZᵢⱼ)/g₁=g₁^{σ}^{ᵢ} [symbol] ΠⱼRᵢⱼ=g₂^{σ}^{ᵢ}}

Where σᵢ=Σⱼrᵢⱼ.

Ballot generation for such a parallel DRE-ip system costs n times that of a two-candidate DRE-ip plus two extra exponentiations to generate the extra proof, i.e. 6.4n+2 exponentiations per ballot in total. Verifying the extra proof takes 2.4 exponentiations, thus well-formedness and consistency verification cost 4.8n+2.4 exponentiations per confirmed ballot and 6.8n+2.4 exponentiations per audited ballot. Tally verification costs n times that of a two-candidate DRE-ip.

In relation to the embodiment of FIG. 3, another technique is to extend DRE-ip and encode a vote for candidate j (j≧1) as vᵢ=M^{j-1}, where M is an upper bound on the number of voters. Hence, Zᵢ=g^{x}^{ᵢ}^{y}^{ᵢ}g^{M}^{^{j-1}} and the proof of well-formedness P_{WF}{Zᵢ} can be constructed as a proof of knowledge of one out of many instead of one out of two discrete logarithms as follows:

$${P}_{K} \{ {x}_{i} \text{:} {}_{j} ( {X}_{i} = {g}^{{x}_{i}} \frac{{Z}_{i}}{{g}^{{M}^{j - 1}}} = {Y}_{i}^{{x}_{i}} ) \}$$

In relation to the embodiment of FIG. 7, another technique is to extend DRE-ip and encode a vote for candidate j (j≧1) as if; =Mⁱ⁻¹, where M is an upper bound on the number of voters. The i-th ballot in this case will be in the form of a triple (Rᵢ, Zᵢ, P_{WF}{Zᵢ}), where Rᵢ=g₂^{ri} and Zᵢ=g₁^{ri}g₁^{Mj-1}. The ballot well-formedness proof P_{WF}{Zᵢ} will be a 1-out-of-n disjunctive proof, rather than 1-out-of-2, and it can be realised as follows.

$${P}_{K} \{ {r}_{i} \text{:} {}_{j} ( {R}_{i} = {g}_{2}^{{r}_{i}} \frac{{Z}_{i}}{{g}_{1}^{{M}^{j - 1}}} = {g}_{1}^{{r}_{i}} ) \}$$

Generation of such a proof costs 2+2.4(n−1)=2.4n−0.4 exponentiations and verifying it 2.4n exponentiations. Ballot calculation in such an “encoded” DRE-ip system costs 2.4n+1.6 exponentiations per ballot. Well-formedness and consistency verification for the system cost 2.4n exponentiations per confirmed ballot and 2.4n+2 exponentiations per audited ballot. Tally verification cost is similar to that of a two-candidate DRE-ip.

The skilled person will appreciate that the present invention is not limited to the above-described exemplary embodiments, and many variations and modifications thereof fall within the scope of the present invention.

For example, any mathematical or physical construct that can provide the following four properties may be used to implement a system of verifiable e-voting without tallying authorities. In the following explanation, a ballot is denoted by a cryptogram, and [yes] and [no] denote the binary cases of the ballot, e.g. in a referendum. The four properties may be referred to as: well-formedness, concealingness, revealingness and self-tallying.
[Well-formedness] Anyone can verify that a given cryptogram is either a [yes] or a [no] ballot—implemented in the above-described exemplary embodiment by verifying a proof of well-formedness included in the cryptogram.
[Concealingness] Given one cryptogram, it is hard to tell if it is a [yes] or a [no]—guaranteed in the above-described exemplary embodiment by the Decision Diffie-Hellman assumption.
[Revealingness] Given both cryptograms or the ephemeral secrets used in constructing the cryptograms, it is easy to tell which one is [yes] and which one is [no]—possible in the above-described exemplary embodiment because [yes]=g·[no].
[Self-tallying] Given a series of cryptograms, one for each ballot, and a count of the number of [yes]s and [no]s, anyone can verify the count—possible in the above-described exemplary embodiment because multiplication cancels out all randomness involved in the encryptions and enables the verification without requiring decryption of individual ballots.

The above-described embodiment may achieve high integrity (i.e., correctness) of the election and in particular of the tally. Furthermore, the above-described embodiment is end-to-end verifiable, and may provide a certain level of privacy ensured by the system under different attack scenarios. For example, the information posted on the bulletin board does not reveal any information about individual votes even if an arbitrary number of other votes are cast by an adversary, and hence the privacy of ballots is preserved against such an adversary. In the event of a more severe attack, in which the adversary gets read access to the voting machine (DRE) for a period of time, in addition to the above capabilities, the privacy of ballots cast outside the adversarial access period is still preserved.

In the following description, the integrity (i.e., correctness) of the election tally in the above-described embodiment is demonstrated. In particular, it is shown how the above-described embodiment achieves end-to-end verifiability: votes are tallied as recorded under the assumption that all proofs of well-formedness are proofs of knowledge; furthermore, voter-initiated auditing guarantees that votes are recorded as cast, and cast as intended.

It is assumed the bulletin board is secure, in particular it is append-only and publicly accessible. Besides, it is assumed there is a mechanism to establish an authenticated channel between authorized DRE(s) and the bulletin board, to ensure that only an authorized DRE can append new values to BB, and also that such values are not modified in transit. This can be achieved using any suitable technique such as digital signatures. Furthermore, it is assumed that the number of voters is less than the size of the group q.

In the method of FIGS. 2 and 3, public verification, i.e., the second step of the tallying phase, includes three types of verification: well-formedness verification, audit consistency verification, and tally verification. The following theorem shows that if well-formedness and tally verifications succeed, the above-described embodiment achieves the tallied-as recorded property, that is, the above-described embodiment may guarantee that the tally on the bulletin board is the correct tally of all the confirmed ballots on the bulletin board.

Theorem 1:

In the above-described embodiment, assuming that all proofs of well-formedness are proofs of knowledge, if the public well-formedness and tally verifications succeed, then the reported tally t is the correct tally of all the confirmed votes on BB.

The full proof is given in the Annex to this description. In short, the following demonstrates how the proofs of well-formedness collectively guarantee that the tally verification equation, i.e., Equation 1: [symbol] Zⱼ=Sg^{t}, holds if and only if t= [symbol] where [symbol] denotes the set of confirmed votes on BB. Hence, if the public well-formedness and tally verifications are carried out successfully, the reported tally t is guaranteed to be the correct tally of all the confirmed votes on BB.

The well-formedness dependency graph for X~ᵢ, \hat{Z}ᵢ and S enforced by the corresponding proofs of well-formedness is illustrated in FIG. 5. As the graph shows, X~ᵢ, \hat{Z}ᵢ and S are all eventually well-formed with respect to four values: g, ĝ, Xᵢ and Yᵢ. Therefore, given fixed g, ĝ, Xᵢ and Yᵢ, the well-formedness proofs guarantee that X~ᵢ, \hat{Z}ᵢ and S are fixed.

Voter initiated auditing includes the following checks: first, by observing the first part of the receipt is provided before deciding to either audit or confirm a ballot, the voter makes sure that DRE commits to the first part of the ballot; second, by checking that the receipts appear on BB verbatim, the voter makes sure that her interaction with the machine is captured faithfully on the bulletin board. The public verification of the consistency of the audited ballots, i.e., the audit consistency verification, guarantees that DRE has been successful in responding to the challenges made by voter initiated auditing. Hence, the individual verification and the public audit consistency verification collectively ensure that voter initiated auditing is correctly executed, faithfully captured, and successfully verified. Consequently, as long as sufficient rounds of audit are performed, the DRE machine will have all but negligible probability of not getting caught if it behaves dishonestly in capturing voter intention, and hence the above-described embodiment would guarantee that the votes are cast as intended and recorded as cast.

Although secure random number generation is necessary to achieve ballot privacy, integrity on the other hand does not require xᵢ and yᵢ to be random. Hence, even if DRE's random number generator is compromised, integrity is guaranteed as long as individual and public verifiability checks succeed and sufficient rounds of voter initiated auditing are carried out.

To show the privacy of the above-described embodiment ballot secrecy and receipt-freeness are considered. Ballot secrecy corresponds to the natural expectation from a voting system to protect the secrecy of cast ballots. One suitable definition of ballot secrecy is one which requires that an adversary controlling the voting behaviour of a group of dishonest voters should not be able to distinguish between any two elections, regardless of how honest voters vote, as long as the two elections have the same sub-tally of honest votes. Receipt-freeness ensures that a voter is not able to prove to a party external to the system how they have voted upon exiting the voting booth. This privacy notion is stronger than ballot secrecy.

In the following description, a secure setup is assumed; that is, it is assumed that the discrete logarithm of g in base g is either not known to any party or securely deleted after the two generators are computed. Secure deletion of values xᵢ, yᵢ and vi after each vote is cast is also assumed. If any of these assumptions is not true, ballot privacy is trivially lost.

Ballot Secrecy under Non-Intrusive Attacks: In one scenario, an adversary does not get access to the voting machine (DRE), but is able to read the publicly available information on the bulletin board, which includes the total tally. It is also assumed that the adversary can control an arbitrary number of voters and, in effect, cast an arbitrary number of votes. The votes cast by the adversary (or more generally, known by the adversary) may be referred to as the adversarial votes. Knowledge of the adversarial votes along with the total tally enables the adversary to find out the tally of the non-adversarial votes. Under the DDH assumption, this is the only information the adversary gains about the non-adversarial votes. In particular, any two elections with the same non-adversarial tally are indistinguishable to the adversary.

To demonstrate these results, two elections are considered in which all votes are the same except for two votes that are swapped. The bulletin boards of these two elections remain indistinguishable to the adversary even if the adversary controls all the votes other than the two that are swapped. More formally:

Lemma 1:

In the above-described embodiment, assuming that all proofs of well-formedness are zero knowledge, if the DDH assumption holds, then an adversary that determines an arbitrary number of votes cannot distinguish between two bulletin boards in which two votes are swapped.

The proof of lemma 1 is given in the Annex to this description. The proof considers an adversary that can determine an arbitrary number of votes except two votes vᵢ and vⱼ. Assuming that such an adversary is able to distinguish the bulletin boards in which vᵢ and vⱼ are swapped, it is shown how the adversary can be used to break the DDH assumption.

Given Lemma 1, it can be expanded to prove that any two elections with the same tally remain indistinguishable to an adversary who controls an arbitrary number of votes. This shows that the only knowledge the adversary can gain about the non-adversarial votes is that disclosed by the election tally.

Theorem 2:

In the above-described embodiment, assuming that all proofs of well-formedness are zero knowledge, if the DDH assumption holds, then an adversary that determines an arbitrary number of votes cannot gain any knowledge about the non-adversarial votes other than their tally.

Proof:

To prove this theorem, it may be shown that under the DDH assumption, given any two sets of non-adversarial votes with the same tally, one can simulate two corresponding bulletin boards that are indistinguishable to an adversary that chooses an arbitrary number of adversarial votes.

First, note that any two given sets of non-adversarial votes with the same tally differ on an even number of votes, say 2d. This means that with d “swaps” one set of these votes can be converted to the other, where in each swap, for some i and j, the i-th vote is replaced with the j-th one, and vice versa. In Lemma 1 it was proved that the bulletin boards before and after each swap remain indistinguishable to the adversary under DDH. Consequently, the bulletin boards corresponding to the two given sets of non-adversarial votes remain indistinguishable to the adversary and the proof is complete.

In comparison with DRE-i, the above-described embodiment provides similar level of security against such non-intrusive attacks as both systems guarantee vote privacy under the DDH assumption.

Ballot Secrecy under Intrusive Attacks: In another scenario, a stronger adversary that apart from the ability to determine an arbitrary number of votes, also gets read access to the voting machine (DRE) storage for a period during the voting phase. That is, the adversary is able to read the contents of the machine memory and storage during the access period. Such an adversary would be able to observe the votes cast during the access period and hence be able to at least work out the tally of the non-adversarial votes cast outside the access period. However, under the Square DDH assumption, this is the only information the adversary gains about the non-adversarial votes. In particular, any two elections in which the non-adversarial votes cast outside the adversarial access period have the same tally are indistinguishable to the adversary. In DRE-i, in the case of an adversarial access to the voting machine storage, the privacy of the ballots cast outside the adversarial access period is also lost. Therefore, while DRE-i falls victim to such intrusive attacks, embodiments of the present invention guarantee vote privacy under the Square DDH assumption.

To demonstrate this result, the following lemma may first be proved.

Lemma 2:

In the above-described embodiment, assuming that all proofs of well-formedness are zero knowledge, if the Square DDH assumption holds, then an adversary that determines an arbitrary number of votes and gets temporary read access to the voting machine (DRE) storage cannot distinguish between two bulletin boards in which two votes cast outside the access period are swapped.

The proof of lemma 2 is given in the Annex to this description. The proof considers an adversary that not only can determine an arbitrary number of votes except two votes vᵢ and vⱼ, but gets access to DRE storage for an arbitrary period. Assuming that such an adversary is able to distinguish the bulletin boards in which vᵢ and vⱼ are swapped, we show how the adversary can be used to break the Square DDH assumption. Basically, the proof shows that even if the value of the sum s is leaked to the adversary, ballot secrecy is still guaranteed, albeit under a stronger assumption.

Lemma 2 can be then expanded to prove the main theorem for ballot secrecy under intrusive attacks:

Theorem 3:

In the above-described embodiment, assuming that all proofs of well-formedness are zero knowledge, if the Square DDH assumption holds, then an adversary that determines an arbitrary number of votes and gets temporary read access to the voting machine (DRE) storage cannot gain any knowledge about the non-adversarial votes other than their tally.

Proof:

To prove theorem 3, it may be shown that under the Square DDH assumption, given any two sets of non-adversarial votes with the same tally, one can simulate corresponding bulletin boards and the extra information the adversary gains through the read access to the voting machine (DRE), and that the simulated elections are indistinguishable to an adversary that chooses an arbitrary number of adversarial votes. The proof is similar to that of Theorem 2 except that here the proof is based on Lemma 2.

### ANNEX

### DRE-Ip: A Verifiable E-Voting Scheme without Tallying Authorities

### Siamak F. Shahandashti and Feng Hao

### School of Computing Science, Newcastle University, UK

Abstract.

Nearly all verifiable e-voting schemes require trustworthy authorities to perform the tallying operations. An exception is the DRE-i system which removes this requirement by pre-computing all encrypted ballots before the election using random factors that will later cancel out and allow the public to verify the tally after the election. While the removal of tallying authorities significantly simplifies election management, the pre-computation of ballots necessitates secure ballot storage, as leakage of precomputed ballots endangers voter privacy. In this paper, we address this problem and propose DRE-ip (DRE-i with enhanced privacy). Adopting a different design strategy, DRE-ip is able to encrypt ballots in real time in such a way that the election tally can be publicly verified without decrypting the cast ballots. As a result, DRE-ip achieves end-to-end verifiability without tallying authorities, similar to DRE-i, but with a significantly stronger guarantee on voter privacy. In the event that the voting machine is fully compromised, the assurance on tallying integrity remains intact and the information leakage is limited to the minimum: only the partial tally at the time of compromise is leaked.

### 1 Introduction

Direct-recording electronic (DRE) machines have been extensively used for voting at polling stations around the world. In a typical process, a registered voter obtains a token after being authenticated at the polling station. She then enters a private booth and presents the token to a DRE machine. The token is for one-time use and allows the voter to cast only one vote. Usually, the DRE machine has a touch screen to record the vote directly from the voter (hence the name DRE). The machine may tally the votes in real time, or store the votes and tally later. In either case, the machine works like a black box: if an attacker maliciously changes the votes (or the tally thereof), this is likely to go unnoticed.

Lack of assurance on tallying integrity is commonly regarded as a critical weakness of such DRE machines. To address this problem, several cryptographic protocols are proposed in the literature. The seminal work by Chaum in 2004 [16] involves using visual cryptography to allow voters to verify the integrity of an election. The assurance on the integrity includes guarantees that the votes are cast as intended, recorded as cast, and tallied as recorded. The fulfilment of all three constitutes the widely-accepted notion of end-to-end (E2E) verifiability.

Chaum's solution inspired a class of voting systems providing E2E verifiability. Prominent examples include MarkPledge [28], Prêt à Voter [29], Scantegrity [14] (and its predecessor PunchScan [21]), Helios [1], and STAR-Vote [4]. These systems are based on different voting media including physical ballots, optical scanners, DREs and web browsers. They use different tallying techniques, based on mix-nets or homomorphic encryption. But all these schemes allow individual voters to verify if their votes have been cast as intended and recorded as cast, and any observer to verify if all votes have been tallied as recorded.

In this paper we limit our attention to DRE-based elections. We focus on DRE as it has already been widely deployed for national elections worldwide. Today, nearly all of the deployed DRE systems work like a black box and offer no guarantee on integrity; consequently, their use has been abandoned in several countries such as the Netherlands, Germany and Ireland. However, in many other countries, these (unverifiable) DRE machines continue to be extensively used. We believe there is an urgent need to address this real-world problem.

Apart from Chaum's system called Votegrity, other existing E2E verifiable schemes for DRE-based elections include MarkPledge [28], VoteBox [31], STAR-Vote [4], and vVote [18]. These systems may differ significantly in details, but they share some common features. They all offer integrity assurance by introducing a set of trustworthy tallying authorities (TAs). Instead of the DRE directly recording the vote, the machine encrypts the vote on the fly under the joint public key of the TAs. Each TA is responsible for safeguarding a share of the decryption key. When voting is closed, a quorum of TAs jointly perform the tallying process which involves decryption of the ballots (or tally thereof) in a publicly-verifiable manner.

The addition of external TAs however introduces difficulties in the implementation. In theory, the TAs should be selected from parties with conflicting interests. They should have the expertise to independently manage their own key shares and perform cryptographic operations, and if they delegate their key management tasks, the delegates need to be trusted as well. A comparatively high level of cryptographic and computing skills is expected from the TAs. Furthermore, the quorum should be set sufficiently large such that collusion among the TAs is infeasible, but at the same time, sufficiently small such that the process is error-tolerant, since non-availability of TA keys will render the election result non-computable. Reconciling the two is not an easy task. As reported by real-world experience of building E2E verifiable voting based on Helios, the implementation of the TAs proved to be “one particularly difficult issue” [2].

Hao et al. investigated if it was possible to achieve E2E verifiability for a DRE-based election without involving any TAs [24]. They proposed a TA-free E2E verifiable voting system, called DRE-i (DRE with integrity). In DRE-i, the machine directly records the voter's choice as in the existing practice of current DRE-based elections. However, the machine is required to publish additional audit data on a public bulletin board, to enable every voter to verify the integrity of the voting process. In DRE-i, the encryption of votes is based on a variant of the ElGamal encryption scheme: instead of using a fixed public key for encryption as in standard ElGamal, DRE-i uses a dynamically constructed public key for encrypting ballots. The system removes the need for TAs by pre-computing encrypted ballots in a structured manner such that after the election, multiplication of all the published ciphertexts cancels out the random factors that were introduced during the encryption process, and permits anyone to verify the tally.

DRE-i demonstrates that the role of the TAs is not indispensable in achieving E2E verifiability in a DRE-based election. However, its pre-computation strategy inevitably introduces the requirement of ensuring that the pre-computed data is securely stored and accessed during the voting phase. Furthermore, it means that it is possible for an adversary that breaks into the secure storage module to potentially compromise the privacy of all ballots. The authors of DRE-i [24] suggest to use tamper-resistant hardware to protect the pre-computed data in sensitive elections. However, the use of tamper-resistant hardware may significantly drive up the cost of each DRE machine. Furthermore, designing secure API for tamper-resistant hardware is a challenging problem on its own.

It remains an open problem as whether it is possible to achieve the best of both worlds, i.e. strong assurance on the integrity of a DRE-based election without involving any TAs, and simultaneously, a strong guarantee on the privacy of votes without depending on tamper-resistant hardware.

In this paper, we provide a positive answer to this question and present a new E2E verifiable voting system, which we call DRE-ip (DRE-i with enhanced privacy). Instead of pre-computing ciphertexts, DRE-ip adopts a more conventional approach, as in other existing DRE-based verifiable systems (see e.g. [31, 4]), to encrypt the vote on the fly during voting. DRE-ip achieves E2E verifiability without TAs, but at the same time provides a significantly stronger privacy guarantee than DRE-i.

### Our Contributions.

We present DRE-ip, an end-to-end verifiable DRE-based voting system that encrypts ballots in real-time, but requires no TAs to decrypt ballots in the tallying phase. We consider intrusive attacks in which the adversary is able to control an arbitrary number of voters and gets read access to the DRE machine for an arbitrary period during the voting phase. We prove that under such attacks, DRE-ip guarantees that elections with the same non-adversarial tally (i.e. tally of the votes neither controlled nor observed by the adversary) remain indistinguishable based on the decision Diffie-Hellman assumption. This shows that in the event of an intrusive attack, only the privacy of the ballots cast during the attack period is lost—a loss which is inevitable—and the ballots cast outside the attack period are guaranteed to remain private. DRE-ip constitutes the first verifiable DRE-based system that removes the need for tallying authorities without introducing new assumptions.

### Related Work.

In his seminal work on anonymous communications, Chaum put forward e-voting as an application of his technique [15]. This prompted considerable research on e-voting, among which is the work of Benaloh [10] that proposed a formal definition of ballot secrecy. Later, Benaloh and Tuinstra argued for receipt-freeness [9], and Juels, Catalano, and Jakobsson put forward coercion-resistance [25] as progressively stronger notions of privacy. On the other hand, verifiability has evolved as a property guaranteeing the integrity of e-voting systems. Earlier works considered individual verifiability. The notion of universal verifiability emerged in later works and Sako and Kilian explicitly formalized it [30]. Finally, through the works of Chaum [16] and Neff [28], notions of verifiability were refined into that of end-to-end verifiability, which includes guarantees that the votes are cast as intended, recorded as cast, and tallied as recorded. End-to-end verifiability has now become a widely-accepted security requirement for e-voting schemes. Accordingly, in this paper, we limit our attention to end-to-end verifiable voting schemes.

There has been a renewed interest in academic research on e-voting in the past fifteen years and a number of end-to-end verifiable schemes have been designed and used in practice. Among the more influential schemes are Votegrity, proposed by Chaum [16], and MarkPledge, proposed by Neff [28], which are the first end-to-end verifiable schemes. Many other schemes follow similar approaches, including Prêt à Voter [29], a tailored variant of which, vVote, has been used in state elections in Victoria, Australia [18], Scantegrity [14], which was trialled in local elections in Takoma Park, Md., USA [13], and STAR-Vote [4], which is scheduled for deployment in elections in Travis County, Tex., USA [26]. Other schemes that have been used in internal university or party elections include PunchScan [21], Bingo Voting [11], Helios [1], Wombat [7], and DRE-i [24].

### 2 Preliminaries

In this section, we review the preliminaries required for description of DRE-ip, including the notation and cryptographic setting we use.

Notation. Following the notation introduced by Camenisch and Stadler [12], we use Pₖ{λ:Γ=y^{λ}} to denote a non-interactive proof of knowledge of (a secret) λ such that (for publicly-known Γ and γ): Γ=γ^{λ}. Where the context is clear, we shorten the notation to Pₖ{λ}. We use P_{WF}{A:X,Y,Z} to denote a proof of well-formedness of A with respect to X, Y, and Z. Where the context is clear, we shorten the notation to P_{WF}{A}.

### 2.1 Cryptographic Setting

We assume a DSA-like multiplicative cyclic group setting, where p and q are large primes that satisfy q|p−1. We work in the subgroup [symbol] _{q} of order q of the group [symbol] *_{q} and assume that g is a generator of [symbol] _{q}. Alternatively, our proposed system can be implemented over an elliptic curve in an ECDSA-like group setting.

The decision Diffie-Hellman (DDH) assumption [19] is defined as follows:

Assumption 1. (DDH) For randomly chosen a, b∈ [symbol] *_{q} and R∈ [symbol] _{q}, given (g,g^{a},g^{b},Ω) where Ω∈{g^{ab},R}, it is hard to decide whether Ω=g^{ab} or Ω=R.

Zero knowledge proofs, first proposed by Goldwasser, Micali, and Rackoff [22], prove the truth of a statement without conveying any other information, i.e. they guarantee that whatever the verifier can feasibly compute after seeing a proof, they could have computed on their own. Subsequent work by Bellare and Goldreich [5] refined the definition of zero knowledge proofs to distinguish them from proofs of knowledge. Intuitively speaking, proofs of knowledge are guaranteed to be generated by a prover with explicit knowledge of a quantity. In our protocol, the Fiat-Shamir heuristic is employed to construct non-interactive proofs [20]. Consequently, our security proofs are in the Random Oracle Model [6].

### 3 Our Proposed Solution: DRE-ip

DRE-ip requires a secure and publicly-accessible bulletin board (BB) and incorporates voter-initiated auditing to achieve end-to-end verifiability. We assume the DRE has append-only write access to the BB over an authenticated channel. We assume voting is conducted in supervised polling stations and there are procedures in place to ensure the “one person, one vote” principle, including secure voter registration and authentication. At the time of voting, a voter is authenticated first and issued a token, unlinked to her identity. She then enters a private voting booth and authenticates herself to the DRE using the token. Up to here, the assumptions and mechanisms are similar to those of DRE-i.

We describe DRE-ip for the case where there are only two candidates, i.e. for vᵢ representing the vote of the i-th ballot, we have vᵢ∈{0,1}. In DRE-ip the setup establishes two generators g₁ and g₂, whose logarithmic relationship is unknown. The DRE keeps track of the running tally t=Σvᵢ for the cast votes vᵢ, and the sum s=Σrᵢ for random rᵢ generated on the fly.

To achieve individual verifiability, DRE-ip incorporates Benaloh-style voter-initiated auditing [8], i.e. the voter gets the option to audit the ballot composed by the DRE to gain confidence in that the DRE is preparing the ballots according to her choice. If a ballot is audited, it cannot be used to cast a vote. Therefore, the set of all ballots [symbol] at the closing of the voting phase will be comprised of the audited ballots [symbol] and the cast ballots [symbol] , i.e. [symbol] = [symbol] ∪ [symbol] .

### Voting Phase.

This phase involves the voter, the DRE, and the BB:
1. The voter enters the booth, initiates voting, and keys in her vote vᵢ∈{0,1}.
2. The DRE generates random rᵢ∈ [symbol] *_{q}, calculates

Rᵢ=g₂^{r}^{ᵢ}, Zᵢ=g₁^{r}^{ᵢ}g₁^{v}^{ᵢ}, P_{WF}{Zᵢ:g₁,g₂,Rᵢ},
and provides a signed receipt including the unique ballot index i and the ballot content Rᵢ, Zᵢ, and P_{WF}{Zᵢ} to the voter.
3. The voter observes that the first part of the receipt is provided, and chooses to either audit the ballot or confirm her vote.
   In case of audit:
4. The DRE adds i to [symbol] , provides a signed receipt of audit, clearly marked audited, including rᵢ and vᵢ to the voter.
5. The voter takes and keeps the receipt, and verifies that vᵢ reflects her choice. If the verification succeeds, voting continues to Step 1; otherwise, the voter should raise a dispute immediately.
   In case of confirmation:
4. The DRE adds i to [symbol] , updates the tally and the sum:

t= [symbol] vⱼ and s= [symbol] rⱼ,
and provides a signed receipt of confirmation, clearly marked confirmed, to the voter, and securely deletes rᵢ and vᵢ.
5. The voter leaves the booth with her receipts.
6. The DRE posts on the BB all the receipts provided to the voter.
7. The voter verifies that her receipts match those on the BB.

### Tallying Phase.

This phase involves the DRE, the BB, and the public:
1. The DRE posts on the BB the final tally t and the final sum s.
2. The Public:
   verify all the well-formedness proofs on the BB (well-formedness verification);
   verify that for all the audited ballots on the BB: Rᵢ and Zᵢ included in the first part of the receipt are consistent with rᵢ and vᵢ included in the second part (and with the system parameters g₁ and g₂) (audit consistency verification); and
   verify that the following equations hold (tally verification):

$${\prod }_{j ∈ ℂ} {R}_{j} {=}^{?} {g}_{2}^{s} and \\ {\prod }_{j ∈ ℂ} {Z}_{j} {=}^{?} {g}_{1}^{s} {g}_{1}^{t} . \qquad ( 1 )$$

If at any point during the voting or tallying phases, any of the verifications carried out by the voter or the public does not succeed, the election staff should be notified and we assume that there are procedures in place dealing with such verification failures. These include voter verifications in Steps 5 (in case of audit) and 7 of the voting phase and public verifications in Step 2 of the tallying phase.

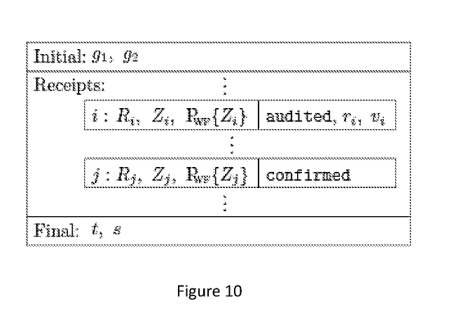

FIG. 10 shows the DRE-ip bulletin board. An audited receipt (with index i) and a confirmed receipt (with index j) are shown. Each receipt has two parts: the first part is provided to the voter before she decides to either audit or confirm her ballot and includes similar information for all receipts; the second part is provided after the voter makes her decision and includes different information based on her choice. Both parts of the receipt are signed by the DRE.

The proof of well-formedness P_{WF}{Zᵢ:g₁,g₂,Rᵢ} can be implemented as a non-interactive proof of knowledge

P_{WF}{Zᵢ}=Pₖ{rᵢ:(Rᵢ=g₂^{r}^{ᵢ} [symbol] Zᵢ=g₁^{r}^{ᵢ}) [symbol] (Rᵢ=g₂^{r}^{ᵢ} [symbol] =Zᵢ/g₁=g₁^{r}^{ᵢ})}.

This proof guarantees that Zᵢ∈{g₁^{r}^{ᵢ},g₁^{r}^{ᵢ}g₁}, or equivalently vᵢ∈{0,1}.

Such a proof can be realized based on Schnorr proofs of knowledge of discrete logarithm [32]. Starting with a Schnorr proof, one can apply techniques proposed by Cramer, Damgard, and Schoenmakers [17] to construct proofs of disjunctive knowledge, conjunctive knowledge, and combinations of both. The Fiat-Shamir heuristic [20] is then applied to make the constructed proofs non-interactive. The index i of the ballot is embedded in the proof (as an input to the hash function) to bind the proof to the ballot.

In practice, truncated hash functions may be used to calculate a short digest, e.g. 4 alphanumeric characters long, of each part of the receipt, so that the voter can easily compare the digests on their receipts with those on the bulletin board. In this case, voters are expected to verify the receipts before leaving the polling station and we assume facilities are provided for them to do so in the station.

### 4 Security of DRE-ip

In this section we provide proofs to show that DRE-ip is end-to-end verifiable and ensures ballot secrecy under both non-intrusive and intrusive attacks.

### 4.1 End-to-End Verifiability

We discuss the integrity (i.e. correctness) of the election tally in DRE-ip and show how DRE-ip achieves end-to-end verifiability: we prove that, assuming all proofs of well-formedness are proofs of knowledge, votes are tallied as recorded if public verification succeeds; furthermore, we demonstrate how voter-initiated auditing guarantees that votes are recorded as cast, and cast as intended.

We assume the bulletin board is secure, in particular it is append-only and publicly accessible. Besides, there should be a mechanism to establish an authenticated channel between authorized DRE(s) and the bulletin board, to ensure that only an authorized DRE can append new values to the BB, and also that such values are not modified in transit. This can be achieved using standard techniques such as digital signatures. Furthermore, we assume that the number of voters is less than the size of the group q.

Recall that public verification in DRE-ip, i.e. Step 2 of the tallying phase, includes three types of verification: well-formedness verification, audit consistency verification, and tally verification. The following theorem shows that if well-formedness and tally verifications succeed, DRE-ip achieves the tallied-as-recorded property, that is, DRE-ip guarantees that the tally on the bulletin board is the correct tally of all the confirmed ballots on the bulletin board.

### Theorem 1.

In DRE-ip, assuming that all proofs of well-formedness are proofs of knowledge, if the public well-formedness and tally verifications succeed, then the reported tally t is the correct tally of all the confirmed votes on the BB.

The proof is rather straightforward and hence omitted here. In short, one can demonstrate how the proofs of well-formedness and the first tally verification check (i.e. the first of the two in Equation 1) collectively guarantee that the second tally verification equation (i.e. the second of the two in Equation 1) holds if and only if t=Σ_{i∈} [symbol] vᵢ, where [symbol] denotes the set of confirmed votes. Hence, if well-formedness and tally verifications are carried out successfully, the reported tally t is guaranteed to be the correct tally of all the confirmed votes on the BB.

Voter initiated auditing includes the following checks: first, by observing the first part of the receipt is provided before deciding to either audit or confirm a ballot, the voter makes sure that the DRE commits to the first part of the ballot; second, by checking that the receipts match what is published on the BB, the voter makes sure that her interaction with the machine is captured faithfully on the bulletin board. The public verification of the consistency of the audited ballots, i.e. the audit consistency verification, guarantees that DRE has been successful in responding to the challenges made by voter initiated auditing. Hence, the individual verification and the public audit consistency verification collectively ensure that the votes are cast as intended and recorded as cast. Theorem 1 ensures that votes are tallied as recorded.

### 4.2 Ballot Secrecy

Ballot secrecy corresponds to the natural expectation from a voting system to protect the secrecy of cast ballots. We consider a definition of ballot secrecy which requires that an adversary controlling the voting behaviour of a group of dishonest voters should not be able to distinguish between any two elections, regardless of how honest voters vote, as long as the two elections have the same partial tally of honest votes. This definition originates from Benaloh [10, p. 74].

We assume a secure setup phase; that is, we assume that the discrete logarithm of g₂ in base g₁ is either not known to any party or securely deleted after the two generators are computed. We also assume secure deletion of values xᵢ, yᵢ, and vᵢ after each vote is cast. See, for instance, [23] and the references within for an overview of available solutions to secure data deletion.

We consider an intrusive adversary that apart from the ability to determine an arbitrary number of votes, gets read access to the DRE storage for a period during the voting phase. The adversary is able to read the publicly available information on the bulletin board, which includes the total tally. Besides, we assume that the adversary can control an arbitrary number of voters, hence in effect cast an arbitrary number of votes. The adversary is able to observe the votes cast during the access period and also read the running (partial) tally t and (partial) sum s.

Let us call the votes cast or observed by the adversary the adversarial votes. Knowledge of the adversarial votes along with the total and partial tallies enables the adversary to find out the tally of the non-adversarial votes cast before and after the adversarial access period. We prove that under the DDH assumption, this is the only information the adversary gains about the non-adversarial votes. In particular, we show that any two elections in which the non-adversarial votes cast before and after the adversarial access period have the same partial tallies are indistinguishable to the adversary. Note that in DRE-i, in case of an adversarial access to the voting machine storage, the privacy of the ballots cast outside the adversarial access period is also lost. Therefore, while DRE-i falls victim to such intrusive attacks, DRE-ip guarantees vote privacy under under such attacks.

We first consider two elections in which all votes are the same except for two votes that are swapped. We show that the bulletin boards of these two elections remain indistinguishable to the adversary as long as these two votes are non-adversarial votes both cast either before or after the adversarial access period. More formally, we have:

### Lemma 1.

In DRE-ip, assuming that all proofs of well-formedness are zero knowledge, if the DDH assumption holds, then an adversary that determines an arbitrary number of votes and gets temporary read access to the DRE storage cannot distinguish between two bulletin boards in which two votes both cast either before or after the adversarial access period are swapped.

The proof of the lemma comes in Appendix A. The proof considers an adversary that not only can determine an arbitrary number of votes except two votes vᵢ and vⱼ, but gets access to DRE storage for an arbitrary period. Assuming that such an adversary is able to distinguish the bulletin boards in which vᵢ and vⱼ are swapped, we show how it can be used to break the DDH assumption. Basically, the proof shows that the sum s does not leak any extra information other than what the tally t does.

Given Lemma 1, we expand it to prove that any two elections with the same non-adversarial partial tallies of the votes cast before and after the adversarial access period remain indistinguishable to an adversary who controls an arbitrary number of votes. This shows that the only knowledge the adversary can gain about the non-adversarial votes cast before and after the adversarial access period is that disclosed by the partial and total tallies.

### Theorem 2.

In DRE-ip, assuming that all proofs of well-formedness are zero knowledge, if the DDH assumption holds, then an adversary that determines an arbitrary number of votes and gets temporary read access to the DRE storage cannot gain any knowledge about the non-adversarial votes cast before and after the adversarial access period other than their partial tallies.

### Proof.

To prove this theorem, we show that under the DDH assumption, given any two sets of non-adversarial votes cast before and after the adversarial access period with the same partial tallies, one can simulate two corresponding bulletin boards that are indistinguishable to an adversary that chooses an arbitrary number of adversarial votes.

First, note that any two given sets of non-adversarial votes with the same partial tally differ on an even number of votes, say 2d. This means that with d “swaps” one set of these votes can be converted to the other, where in each swap, for some i and j, the i-th vote is replaced with the j-th one, and vice versa. In Lemma 1 we proved that the bulletin boards before and after each swap remain indistinguishable to the adversary under DDH. Consequently, the bulletin boards corresponding to the two given sets of non-adversarial votes remain indistinguishable to the adversary and the proof is complete. □

We discussed the case for a single adversarial access period, but the above theorem guaranteeing ballot secrecy can be easily extended to cover attacks involving multiple adversarial access periods.

### 5 Comparison

In this section we look at how DRE-ip compares with other DRE-based verifiable e-voting systems. In particular, we consider Chaum's Votegrity [16], Neff's MarkPledge [28], VoteBox [31], STAR-Vote [4], DRE-i [24], and vVote [18].

Votegrity is based on visual cryptography and uses onion encryption. MarkPledge employs a purpose-designed encryption scheme that allows challenge-response-style individual verifiability. VoteBox and STAR-Vote are both based on exponential ElGamal encryption which allows homomorphic tallying. In vVote, ballots are encrypted using elliptic curve ElGamal and later decrypted individually after mixing. DRE-i on the other hand uses encryption that does not admit to a fixed decryption key. DRE-ip basically uses the exponential ElGamal encryption in which no party knows the decryption key. All these systems consider voter registration and voter authentication outside their scope and assume they are carried out correctly and securely.

In general, systems that require tallying authorities, i.e. Votegrity, MarkPledge, VoteBox, STAR-Vote, and vVote, assume a minimum number of them are available at the tallying phase to compute the election tally. DRE-i and DRE-ip do not require such an assumption to guarantee availability.

To guarantee integrity, all systems we consider rely on a secure bulletin board and on a sufficient number of voters carrying out individual verification.

TABLE 1
Selected security assumptions for DRE-based verifiable e-voting systems. TA: tallying
authority, VIA: voter-initiated auditing, BB: bulletin board, RNG: random number
generation, ▪: assumption is required, □: assumption is not required.

| | | | | Privacy | | | | |
|---|---|---|---|---|---|---|---|---|
| | Availability | Integrity | | | | | Secure | Trust- |
| | Reliable | Sufficient | Secure | Secure | Secure | Secure | ballot | worthy |
| System | TA(s) | VIA | BB | setup | RNG | deletion | storage | TA(s) |
| Votegrity | ▪ | ▪ | ▪ | ▪ | ▪ | ▪ | □ | ▪ |
| MarkPledge | ▪ | ▪ | ▪ | ▪ | ▪ | ▪ | □ | ▪ |
| VoteBox | ▪ | ▪ | ▪ | ▪ | ▪ | ▪ | □ | ▪ |
| STAR-Vote | ▪ | ▪ | ▪ | ▪ | ▪ | ▪ | □ | ▪ |
| DRE-i | □ | ▪ | ▪ | ▪ | ▪ | ▪ | ▪ | □ |
| vVote | ▪ | ▪ | ▪ | ▪ | ▪ | ▪ | □ | ▪ |
| DRE-ip | □ | ▪ | ▪ | ▪ | ▪ | ▪ | □ | □ |

Systems that require tallying authorities, i.e. Votegrity, MarkPledge, VoteBox, STAR-Vote, and vVote, also require that the tallying authorities perform the decryption of the tally correctly. In a verifiable system, this is enforced by requiring the tallying authorities to produce universally verifiable proofs of correct decryption. Hence, we consider assumptions underlying all the systems to guarantee integrity to be comparable, whether the system requires tallying authorities or not.

To guarantee privacy, all systems we consider assume a secure setup phase to generate and distribute system parameters and keys, as well as secure random number generators to produce the randomness required for probabilistic encryption. Furthermore, all systems assume that the captured votes and any ephemeral secrets generated for the cryptographic operations during the voting phase are securely erased. Votegrity is based on decryption mix-nets and requires that the tallying authorities do not collude to compromise voter privacy. MarkPledge and vVote employ re-encryption mix-nets to shuffle encrypted ballots before decryption, and assume that the tallying authorities do not decrypt ballots before mixing although they are available on the bulletin board. VoteBox and STAR-Vote require that the tallying authorities do not collude to decrypt individual ballots. DRE-i does not require this assumption, but instead relies on a secure ballot storage mechanism to keep the pre-computed ballots safe after the setup phase. DRE-ip does not require trust assumptions on tallying authorities or ballot storage.

Table 1 summarizes the main similarities and differences in terms of their underlying security assumptions between the voting systems we consider.

Let us now compare the computation complexity of DRE-ip with that of the other DRE-based verifiable e-voting systems. We do not consider Votegrity, MarkPledge, and vVote since they use mix-nets and their computation complexity depend on how these verifiable mix-nets are implemented. All calculations are based on a two-candidate election, encryption implemented based on exponential ElGamal, and one TA if present. Note that having multiple TAs increases the complexity of tally calculation and verification for all the schemes requiring tallying authorities.

TABLE 2
Computation complexity of selected DRE-based verifiable e-voting systems.

| | Ballot | Well-formedness and | Tally | Tally |
|---|---|---|---|---|
| System | calculation | consistency verification | calculation | verification |
| VoteBox | 6.4\|B\| e | (6.8\|A\| + 4.8\|C\|) e | \|C\| m + 3 e | \|C\| m + 2.4 e |
| STAR-Vote | 6.4\|B\| e | (6.8\|A\| + 4.8\|C\|) e | \|C\| m + 3 e | \|C\| m + 2.4 e |
| DRE-i | 10.8\|B\| e | (9.6\|A\| + 4.8\|C\|) e | | \|B\| m + 1 e |
| DRE-ip | 6.4\|B\| e | (6.8\|A\| + 4.8\|C\|) e | | 2\|C\| m + 2 e |

B, A, C: all, audited, confirmed ballots, e: exponentiation, m: multiplication.

We assume in all systems that the TA, if present, provides proofs of correct decryption as required by end-to-end verifiability. We also assume that the simultaneous multiple exponentiation (SME) technique [27] is used to optimize computations. Using SME, a term of the form g^{x}h^{y} costs equivalent to around 1.2 exponentiations to calculate.

The systems considered here use two types of well-formedness proof in general. The first type consists of proofs of (knowledge and) equality of two discrete logarithms and are of the general form

Pₖ{λ:Γ₁=γ₁^{λ} [symbol] Γ₂=γ₂^{λ}}. (2)

Consider an exponential ElGamal encryption scheme with key pair (k,K=g^{k}) in which a message m is encrypted to the ciphertext (R=g^{r},C=K^{r}g^{m}). The proof

P_{WF}{m:g,K,(R,C)}=P_{K}{k:K=g^{k} [symbol] C/g^{m}=R^{k}}

which is of the form of Equation 2 can be used as a proof of correct decryption, e.g. in systems like VoteBox and STAR-Vote. Such a proof, when realized as a Fiat-Shamir non-interactive Schnorr proof and optimized using the SME technique, requires 2 exponentiations to generate, and (equivalent to) around 2.4 exponentiations to verify. Algorithms for generation and verification of such proofs are transcribed in Appendix B.

The second type consists of disjunctive proofs of equality (and knowledge) of either one pair of discrete logarithms or the other, and are of the general form

P_{K}{λ:(Γ₁=γ₁^{λ} [symbol] Γ₂=γ₂^{λ}) [symbol] (Γ₃=γ₃^{λ} [symbol] Γ₄=γ₄^{λ})} (3)

Such proof can be constructed as a disjunction of two conjunctive proofs of the form of Equation 2. These proofs can be used to prove well-formedness of the ballots in all the systems we consider. In DRE-ip, the ballot well-formedness proof P_{WF}{Zᵢ:g₁,g₂,Rᵢ} is of this form. This proof, when realized as a Fiat-Shamir non-interactive Schnorr proof and optimized using the SME technique, requires (equivalent to) around 4.4 exponentiations to generate, and (equivalent to) around 4.8 exponentiations to verify. Algorithms for generation and verification of such proofs are transcribed in Appendix B.

VoteBox and STAR-Vote both encrypt the vote under exponential ElGamal, which involves similar computation as that of DRE-ip. In DRE-ip, calculating Rᵢ and Zᵢ take 1 exponentiation each, and calculating P_{WF}{Zᵢ} takes around 4.4 exponentiations. Hence, ballot calculation takes around 6.4 exponentiations per ballot in VoteBox, STAR-Vote, and DRE-ip. In DRE-i, two proofs of well-formedness are (pre-)calculated for each ballot and hence ballot calculation requires 10.8 exponentiations per ballot.

In all four systems, checking well-formedness of a confirmed ballot consists of verifying a proof of the second type discussed above, so it takes around 4.8 exponentiations per confirmed ballot. Consistency verification of an audited ballot consists of checking well-formedness of the ballot plus verifying whether the revealed audit information is consistent with the ballot. In VoteBox, STAR-Vote, and DRE-ip, the computation involved is similar. In DRE-ip for example, Rᵢ and Zᵢ are recalculated based on the revealed values of rᵢ and vᵢ and the result is compared against reported values of Rᵢ and Zᵢ on the BB. This takes 2 exponentiations, and hence consistency verification takes around 6.8 exponentiations per audited ballot. In DRE-i, there is an extra proof of the second type discussed above to verify for each audited ballot and hence consistency verification takes around 9.6 exponentiations per audited ballot.

In VoteBox and STAR-Vote, tally calculation requires all confirmed vote encryptions to be multiplied, the result decrypted, and finally a proof of correct decryption generated. Decryption and generating the proof of correct decryption require 1 and 2 exponentiations, respectively. These calculations are obviously carried out by the TAs. In DRE-i and DRE-ip, tallies are kept track of and reported by the DRE, so no extra calculation is needed.

Tally verification in VoteBox and STAR-Vote consists of multiplying confirmed vote encryptions and verifying the proof of correct decryption. The latter costs around 2.4 exponentiations as discussed above. In DRE-i, a tally verification equation is checked which requires multiplication of all vote encryptions and 1 exponentiation. In DRE-ip, two tally verification equation are checked which require multiplication of all Rᵢ and also all Zᵢ for confirmed ballots and an exponentiation per equation.

Table 2 summarizes the computation complexity of different operations in the systems we discussed above. Note that our calculations above and figures listed in the table do not include the cost of validating the inputs to the verification algorithms to ensure that they belong to the right cryptographic groups. In elliptic curve based implementations of the systems discussed above, such validations incur negligible cost.

### 6 Extension to Multiple Candidates

Although we have described DRE-ip for two candidates only, there are two rather standard ways to extend it to support multiple candidates (see e.g. [24, 3]). Here we discuss voting for 1 out of n candidates for n≧3.

A straightforward method is to essentially run a separate parallel DRE-ip system for each candidate. Let vᵢⱼ represent the vote in ballot i and candidate j. 1 out of n votes include a vᵢⱼ=1 vote for one candidate and vᵢⱼ=0 votes for all other candidates.

TABLE 3
Computation complexity of DRE-ip supporting
voting for 1 out of n ≧ 3 candidates.

| DRE-ip | Ballot | Well-formedness and | Tally |
|---|---|---|---|
| extension | calculation | consistency verification | verification |
| Parallel | (6.4n + 2)\|B\| e | ((6.8n + 2.4)\|A\| + (4.8n + 2.4)\|C\|) e | 2n\|C\| m + 2n e |
| Encoded | (2.4n + 1.6)\|B\| e | ((2.4n + 2)\|A\| + 2.4n \|C\|) e | 2\|C\| m + 2 e |

B, A, C: all, audited, confirmed ballots, e: exponentiation, m: multiplication.

Hence, an extra proof of well-formedness is required to guarantee that only one of the votes vᵢⱼ over all values of j is 1. The i-th ballot in this case will be in the form of a (3n+1)-tuple: ((Rᵢⱼ,Zᵢⱼ,P_{WF}{Zᵢⱼ})ⱼ₌₁ⁿ,π), where π represents the extra proof. Since for each j the well-formedness proof P_{WF}{Zᵢⱼ} already guarantees that vᵢⱼ∈{0,1}, it would be sufficient for the extra proof to only show that Σⱼ₌₁ⁿvᵢⱼ=1. Interestingly, given the values Rᵢⱼ=g₂^{r}^{ᵢⱼ}, this proof can be easily constructed as the proof of knowledge

P_{K}{(σᵢ:(Πⱼ₌₁ⁿZᵢⱼ)/g₁=g₁^{σ}^{ᵢ} [symbol] Πⱼ₌₁ⁿRᵢⱼ=g₂^{σ}^{ᵢ}}, where σᵢ=Σⱼ₌₁ⁿrᵢⱼ.

This is a proof of the first type discussed above (i.e. of the form of Equation 2). Ballot generation for such a parallel DRE-ip systems costs n times that of a two-candidate DRE-ip plus 2 extra exponentiations to generate the extra proof, i.e. 6.4n+2 exponentiations per ballot in total. Verifying the extra proof takes 2.4 exponentiations, thus well-formedness and consistency verification cost 4.8n+2.4 exponentiations per confirmed ballot and 6.8n+2.4 exponentiations per audited ballot. Tally verification costs n times that of a two-candidate DRE-ip.

Another method is to extend DRE-ip and encode a vote for candidate j as vᵢ=M^{j-1}, where M is an upper bound on the number of voters. The i-th ballot in this case will be in the form of a triple (Rᵢ,Zᵢ,P_{WF}{Zᵢ}), where Rᵢ=g₂^{r}^{ᵢ} and Zᵢ=g₁^{r}^{ᵢ}g₁^{M}^{^{j-1}}. The ballot well-formedness proof P_{WF}{Zᵢ} will be a 1-out-of-n disjunctive proof, rather than 1-out-of-2, and it can be realized as follows:

$${P}_{K} \{ {r}_{i} \text{:} {{}_{j = 1}}^{n} ( {R}_{i} = ( {g}_{2}^{{r}_{i}} ) {Z}_{i} / {g}_{1}^{{M}^{j - 1}} = {g}_{1}^{{r}_{i}} ) \} .$$

This is an extended version of a proof of the second type discussed above (i.e. of the form of Equation 3). Generation of such a proof costs 2+2.4(n−1)=2.4n−0.4 exponentiations and verifying it 2.4n exponentiations. Ballot calculation in such an “encoded” DRE-ip system costs 2.4n+1.6 exponentiations per ballot. Well-formedness and consistency verification for the system cost 2.4n exponentiations per confirmed ballot and 2.4n+2 exponentiations per audited ballot. Tally verification cost is similar to that of a two-candidate DRE-ip.

Table 3 summarizes the computation complexity for the two extensions. Overall, while parallel DRE-ip is more modular and hence more straightforward to implement, encoded DRE-ip is more efficient. A similar observation seems to hold for extended versions of VoteBox, STAR-Vote, and DRE-i.

### 7 Concluding Remarks

In this paper we revisited the design of the DRE-i voting system and proposed a new system: DRE-ip. On the theoretical level, we have shown that it is possible to have verifiable DRE-based voting systems in which the privacy of the ballots does not rely on trustworthy tallying authorities or trusted hardware. On the practical level, we have shown that DRE-ip provides an efficient and practical verifiable DRE-based voting solution able to preserve the privacy of the ballots even if the adversary gets temporary read access to the voting machine during the voting phase. Designing a system without tallying authorities that can efficiently support more complex electoral systems such as single transferable vote (STV) or write-in candidates remains an open problem.

### REFERENCES

[1] B. Adida. Helios: Web-based open-audit voting. In USENIX Security Symp., volume 17, pages 335-348, 2008.
[1] B. Adida, O. de Marneffe, O. Pereira, and J.-J. Quisquater. Electing a university president using open-audit voting: Analysis of real-world use of Helios. In EVT/WOTE'09, page 10. USENIX, 2009.
[3] 0. Baudron, P.-A. Fouque, D. Pointcheval, J. Stern, and G. Poupard. Practical multi-candidate election system. In ACM Symp. on Principles of Distributed Computing, PODC '01, pages 274-283. ACM, 2001.
[4] S. Bell, J. Benaloh, M. D. Byrne, D. DeBeauvoir, B. Eakin, G. Fisher, P. Kortum, N. McBurnett, J. Montoya, M. Parker, O. Pereira, P. B. Stark, D. S. Wallach, and M. Winn. STAR-Vote: A secure, transparent, auditable, and reliable voting system. USENIX Journal of Election Technology & Systems, 1(1):18-37, 2013.
[5] M. Bellare and O. Goldreich. On defining proofs of knowledge. In E. F. Brickell, editor, Crypto'92, volume 740 of LNCS, pages 390-420. Springer, 1993.
[6] M. Bellare and P. Rogaway. Random oracles are practical: A paradigm for designing efficient protocols. In ACM CCS'93, pages 62-73. ACM, 1993.
[7] J. Ben-Nun, M. Llewellyn, B. Riva, A. Rosen, A. Ta-Shma, and D. Wikstrom. A new implementation of a dual (paper and cryptographic) voting system. In EVOTE2012: 5th Int'l Conf. on Electronic Voting, pages 315-329, 2012.
[8] J. Benaloh. Ballot casting assurance via voter-initiated poll station auditing. In USENIX Workshop on Accurate E-Voting Technology (EVT), page 14, 2007.
[9] J. Benaloh and D. Tuinstra. Receipt-free secret-ballot elections. In ACM Symp. on Theory of Computing, STOC '94, pages 544-553. ACM, 1994.
[10] J. D. C. Benaloh. Verifiable Secret-Ballot Elections. PhD thesis, Department of Computer Science, Yale University, 1987.
[11] J.-M. Bohli, J. Müller-Quade, and S. Röhrich. Bingo voting: Secure and coercion-free voting using a trusted random number generator. In E-Voting and Identity, pages 111-124. Springer, 2007.
[12] J. Camenisch and M. Stadler. Efficient group signature schemes for large groups. In Crypto'97, volume 1294 of LNCS, pages 410-424. Springer, 1997.
[13] R. Carback, D. Chaum, J. Clark, J. Conway, A. Essex, P. Herrnson, T. Mayberry, S. Popoveniuc, R. Rivest, E. Shen, A. Sherman, and P. Vora. Scantegrity II municipal election at Takoma Park: The first E2E binding governmental election with ballot privacy. In USENIX Security Symp., pages 291-306, 2010.
[14] D. Chaum, R. Carback, J. Clark, A. Essex, S. Popoveniuc, R. Rivest, P. Ryan, E. Shen, A. Sherman, and P. Vora. Scantegrity II: End-to-end verifiability by voters of optical scan elections through confirmation codes. Information Forensics and Security, IEEE Transactions on, 4(4):611-627, December 2009.
[15] D. L. Chaum. Untraceable electronic mail, return addresses, and digital pseudonyms. Communications of the ACM, 24(2):84-90, 1981.
[16] D. L. Chaum. Secret-ballot receipts: True voter-vrifiable elections. IEEE security & privacy, 2(1):38-47, 2004.
[17] R. Cramer, I. Damgard, and B. Schoenmakers. Proofs of partial knowledge and simplified design of witness hiding protocols. In Y. Desmedt, editor, Crypto'94, volume 839 of LNCS, pages 174-187. Springer, 1994.
[18] C. Culnane, P. Y. A. Ryan, S. Schneider, and V. Teague. vVote: A verifiable voting system. ACM Trans. Inf. Syst. Secur., 18(1):3:1-3:30, June 2015.
[19] W. Diffie and M. E. Hellman. New directions in cryptography. Information Theory, IEEE Transactions on, 22(6):644-654, November 1976.
[20] A. Fiat and A. Shamir. How to prove yourself: Practical solutions to identification and signature problems. In A. M. Odlyzko, editor, Crypto'86, volume 263 of LNCS, pages 186-194. Springer, 1987.
[21] K. Fisher, R. Carback, and A. T. Sherman. Punchscan: Introduction and system definition of a high-integrity election system. In Workshop on Trustworthy Elections (WOTE), 2006.
[22] S. Goldwasser, S. Micali, and C. Rackoff. The knowledge complexity of interactive proof systems. SIAM Journal on Computing, 18(1):186-208, 1989.
[23] F. Hao, D. Clarke, and A. Zorzo. Deleting secret data with public verifiability. IEEE Transactions on Dependable and Secure Computing, PP(99):1, 2015.
[24] F. Hao, M. N. Kreeger, B. Randell, D. Clarke, S. F. Shahandashti, and P. H.-J. Lee. Every vote counts: Ensuring integrity in large-scale electronic voting. USENIX Journal of Election Technology & Systems, 2(3):1-25, 2014.
[25] A. Juels, D. Catalano, and M. Jakobsson. Coercion-resistant electronic elections. In Privacy in Electronic Society, WPES'05, pages 61-70. ACM, 2005.
[26] A. Lim. Travis County, Tex. developing electronic voting system with a paper trail. Government Technology, July 2014. www.govtech.com (accessed October 2015).
[27] A. J. Menezes, P. C. van Oorschot, and S. A. Vanstone. Handbook of Applied Cryptography. CRC press, 1996.
[28] C. A. Neff. Practical high certainty intent verification for encrypted votes, 2004. Avalable from http://citeseer.ist.psu.edu.
[29] P. Ryan, D. Bismark, J. Heather, S. Schneider, and Z. Xia. Prêt à Voter: a voter-verifiable voting system. IEEE T. Inf. Foren. Sec., 4(4):662-673, December 2009.
[30] K. Sako and J. Kilian. Receipt-free mix-type voting scheme. In EuroCrypt'95, volume 921 of LNCS, pages 393-403. Springer, 1995.
[31] D. Sandler, K. Derr, and D. S. Wallach. VoteBox: A tamper-evident, verifiable electronic voting system. In USENIX Security Symp., volume 4, page 87, 2008.
[32] C.-P. Schnorr. Efficient signature generation by smart cards. Journal of cryptology, 4(3):161-174, 1991.

### A Proof of Lemma 1

We first consider the following assumption and prove that it is implied by DDH:

### Assumption 2.

For randomly chosen a, b∈ [symbol] *_{q}, given (g,g^{b},g^{ab},Ω) where Ω∈{g^{a},g^{a+1}}, it is hard to decide whether Ω=g^{a} or Ω=g^{a+1}.

### Lemma 2.

The DDH assumption implies Assumption 2.

### Proof.

Taking h=g^{b} as the new generator, and assuming x=a and y=b⁻¹, we have g=h^{y}, g^{b}=h, g^{ab}=h^{x}, and g^{a}=h^{xy}. Therefore, the assumption can be rewritten as follows for generator h: for randomly chosen x,y∈ [symbol] *_{q}, given (h,h^{x},h^{y},Ω), where Ω∈{h^{xy},h^{xy+1}}, it is hard to decide whether Ω=h^{xy} or Ω=h^{xy+1}. This assumption is proven to be implied by DDH by Hao et al. [24] and hence the proof is complete. □

Now we show that Lemma 1 holds under Assumption 2.

### Proof (of Lemma 1).

Let A be an adversary that, after determining a number of votes and obtaining temporary access to the voting machine, distinguishes the two bulletin boards. We construct an algorithm D that given g, g^{b}, g^{ab}, and a challenge Ω∈{g^{a},g^{a+1}} distinguishes which Ω is given.

Consider an abridged bulletin board resulting from removing the well-formedness proofs. Let us call this the bare bulletin board. Let the adversary determine any subset of votes other than the swapped votes vᵢ and vⱼ. A has access to the bulletin board. Furthermore, A has temporary access to the voting machine which means it can observe some votes vₖ and their respective secret values rₖ, and also the value of s=Σₗ₌₁^{k}rₗ for the duration of its access. Therefore, apart from simulating the values on the bulletin board, D ought to provide the adversary with the values of rₖ and s=Σₗ₌₁^{k}rₗ for a subset of the votes cast or audited during the adversarial access period.

D simulates the bare bulletin board as follows. We describe how confirmed ballots are constructed. Audited ballots can be easily calculated since rₖ and vₖ are known to D for all k∉{i,j}. Recall that ballots i and j are confirmed ballot, both cast either before or after the adversarial access period.

D posts g₁=g and g₂=g^{b} as the initial parameters on the bulletin board. For all k∉{i,j}, D simply chooses rₖ randomly and generates the ballot according to the protocol. D generates random αᵢ and αⱼ and calculates the i-th and j-th ballots as follows. First, D sets

Rᵢ=(g^{b})^{α}^{ᵢ}g^{ab}, Zᵢ=g^{α}^{ᵢ}Ω, Rⱼ=(g^{b})^{α}^{ⱼ}/g^{ab}, Zⱼ=g^{α}^{ⱼ}⁺¹/Ω.

Assuming implicitly that rᵢ=αᵢ+α and rⱼ=αⱼ−α, we can see that Rᵢ and Rⱼ are well-formed since:

Rᵢ=(g^{b})^{α}^{ᵢ}g^{ab}=(g^{b})^{α}^{ᵢ}^{+a}=g₂^{r}^{ᵢ}, Rⱼ=(g^{b})^{α}^{ⱼ}/g^{ab}=(g^{b})^{α}^{ⱼ}^{-a}=g₂^{r}^{ⱼ}.

Now if Ω=g^{a}, then we have

Zᵢ=g^{α}^{ᵢ}Ω=g^{α}^{ᵢ}^{+a}=g₁^{r}^{ᵢ}, Zⱼ=g^{α}^{ⱼ}⁺¹/Ω=g^{α}^{ⱼ}^{-a}g=g₁^{r}^{ⱼ}g₁.

On the other hand, if Ω=g^{a+1}, then we have

Zᵢ=g^{α}^{ᵢ}Ω=g^{α}^{ᵢ}^{+a}g=g₁^{r}^{ᵢ}g₁, Zⱼ=g^{α}^{ⱼ}⁺¹/Ω=g^{α}^{ⱼ}^{-a}=g₁^{r}^{ⱼ}.

In other words, Ω=g^{a} corresponds to a bulletin board with vᵢ=0 and vⱼ=1, and Ω=g^{a+1} corresponds to a bulletin board with vᵢ=1 and vⱼ=0, with all other votes being identical in the two bulletin boards.

Since all the votes other than vᵢ and vⱼ are known to D, it can calculate the partial tallies of the votes other than vᵢ and vⱼ cast before, during, and after the adversarial access period. In addition, we have either vᵢ=0 and vⱼ=1, or vᵢ=1 and vⱼ=0, hence vᵢ+vⱼ=1. So whether both vᵢ and vⱼ are cast before or after the adversarial access period, the partial tallies of all votes (including vᵢ and vⱼ) cast before, during, and after the the adversarial access period can be easily calculated by D.

A similar argument holds for the random values: all random values except for rᵢ and rⱼ are known to D, and for rᵢ and rⱼ we implicitly have:

rᵢ+rⱼ=(αᵢ+a)+(αⱼ−a)=αᵢ+aⱼ

which means that rᵢ+rⱼ is known to D. Hence following a similar reasoning, whether both vᵢ and vⱼ are cast before or after the adversarial access period, the partial sums of all random values (including rᵢ and rⱼ) for votes cast before, during, and after the the adversarial access period can be easily simulated by D.

Thus, D is able to simulate all the elements of a bare bulletin board and the internal DRE information revealed to the A during the adversarial access period. Since the well-formedness proofs are assumed to be zero knowledge, they can be simulated in the Random Oracle Model for ballots i and j, and the simulated proofs remain indistinguishable from real proofs. Consequently, D is able to simulate a full bulletin board corresponding to one of the two cases, with Ω=g^{a} corresponding to the case where vᵢ=0 and vⱼ=1, and Ω=g^{a+1} corresponding to vᵢ=1 and vⱼ=0, with all other votes being identical in the two bulletin boards. Now if A is able to distinguish the two cases, D will be able to distinguish whether Ω=g^{a} or Ω=g^{a+1} and hence the proof is complete. □

### B Well-Formedness Proofs

The first type of proofs are proofs of equality and knowledge of two discrete logarithms. The proof generation and verification procedures are shown in Algorithms 1 and 2 on page 19, respectively.

The second type of proofs are disjunctive proofs of equality and knowledge of either a first pair of discrete logarithms or a second pair. The proof generation and verification procedures are shown in Algorithms 3 and 4 on page 19, respectively. Algorithm 3 is written for the case where the prover knows the first pair of discrete logarithms. The algorithm for the case where the prover knows the second pair can be obtained by straightforward modifications.

Algorithm 1: A prover with identifier ID generates a
proof of knowledge of a secret λ s.t. Γ₁ = γ₁^{λ}
and Γ₂ = γ₂^{λ} for known ID, γ₁, Γ₁, γ₂, Γ₂

Input: ID, γ₁, Γ₁, γ₂, Γ₂, λ s.t. Γ₁ = γ₁^{λ} and Γ₂ = γ₂^{λ}
Output: ζ = P_{K}{λ : Γ₁ = γ₁^{λ} [symbol] Γ₂ = γ₂^{λ}}
begin
| choose random w ∈ [symbol] _{q}
| calculate t₁ = γ₁^{w} and t₂ = γ₂^{w}
| calculate c = H(ID, γ₁, Γ₁, γ₂, Γ₂, t₁, t₂)
| calculate r = w − cλ
└ return ζ = (c, r)

Algorithm 2: Verification of a proof ζ generated by Algorithm
1 against ID, γ₁, Γ₁, γ₂, Γ₂

Input: ID, γ₁, Γ₁, γ₂, Γ₂, ζ = (c, r)
Output: valid or invalid
begin
| calculate t₁ = γ₁^{r}Γ₁^{c} and t₂ = γ₂^{r}Γ₂^{c}
| calculate c′ = H(ID, γ₁, Γ₁, γ₂, Γ₁, t₁, t₂)
| if c = c′ then return valid
└ else return invalid

Algorithm 3: A prover with identifier ID generates a proof of
knowledge of a secret λ s.t. either Γ₁ = γ₁^{λ} and Γ₂ = γ₂^{λ} or
Γ₃ = γ₃^{λ} and Γ₄ = γ₄^{λ} for known ID, γ₁, Γ₁, . . . , γ₄, Γ₄

Input: ID, (γᵢ, Γᵢ)ᵢ₌₁⁴, λ s.t. Γ₁ = γ₁^{λ} and Γ₂ = γ₂^{λ}
Output: ζ = P_{K}{λ : (Γ₁ = γ₁^{λ} [symbol] Γ₂ = γ₂^{λ}) [symbol] (Γ₃ = γ₃^{λ} [symbol] Γ₄ = γ₄^{λ})}
begin
| choose random w, r₂, c₂ ∈ [symbol] _{q}
| calculate t₁ = γ₁^{w}, t₂ = γ₂^{w}, t₃ = γ₃^{r2}Γ₃^{c2}, t₄ = γ₄^{r2}Γ₄^{c2}
| calculate c = H(ID, (γᵢ, Γᵢ)ᵢ₌₁⁴, (tᵢ)ᵢ₌₁⁴), c₁ = c − c₂
| calculate r₁ = w − c₁λ
└ return ζ = (c₁, c₂, r₁, r₂)

Algorithm 4: Verification of a proof ζ generated by Algorithm
3 against ID, γ₁, Γ₁, . . . , γ₄, Γ₄

Input: ID, (γᵢ, Γᵢ)ᵢ₌₁⁴, ζ = (c₁, c₂, r₁, r₂)
Output: valid or invalid
begin
| calculate t₁ = γ₁^{r1} Γ₁^{c1}, t₂ = γ₂^{r1} Γ₂^{c1}, t₃ = γ₃^{r2} Γ₃^{c2}, t₄ = γ₄^{r2}, Γ₄^{c2}
| calculate c′ = H(ID, (γᵢ, Γᵢ)ᵢ₌₁⁴, (tᵢ)ᵢ₌₁⁴)
| if c₁ + c₂ = c′ then return valid
└ else return invalid

1. A method for electronic voting, the method comprising:
receiving a selection of a vote vᵢ from a voter;
generating one or more first values associated with the voter;
calculating one or more second values based on the one or more first values;
providing a first type of receipt including the one or more second values to the voter;
updating a tally, t, based on the vote vᵢ;
updating a sum, s, based on the one or more first values; and
publishing the receipt including the one or more second values.

2. A method according to claim 1, wherein the vote vᵢ, {0,1}.

3. A method according to claim 1, wherein the one or more first values comprise random values xᵢ,yᵢ, Z*_{q}.

4. A method according to claim 3, wherein the one or more second values comprise

| | | | |
|---|---|---|---|
| Xᵢ = g^{xi} | Yᵢ = g^{yi} | X\tilde{ }ᵢ = ĝ^{xi} | P_{WF}{X\tilde{ }ᵢ: g, Xᵢ, ĝ} |
| Zᵢ = g^{xiyi}g^{vi} | P_{WF}{Zᵢ: g, Xᵢ, Yᵢ} | \hat{Z}ᵢ = ĝ^{xi}_{yi} | P_{WF}{\hat{Z}ᵢ: g, Yᵢ, Xᵢ} |

wherein g and ĝ are fixed parameters, and wherein P_{WF}{A:X,Y,Z} denotes a proof of well-formedness of A with respect to X, Y and Z.

5. A method according to claim 4, wherein ĝ=g^{r}, where r is a random number (e.g. that is unknown to anyone).

6. A method according to claim 1, wherein the one or more first values comprise a random value rᵢ, [symbol] *_{q}.

7. A method according to claim 6, wherein the one or more second values comprise
Rᵢ=g₂^{r}^{ᵢ}
Zᵢ=g₂^{r}^{ᵢ}g₁^{v}^{ᵢ}
P_{WF}{Zᵢ:g₁,g₂,Rᵢ}

8. A method according to claim 7, wherein g₂=g₁^{r}, where r is a random number (e.g. that is unknown to anyone).

9. A method according to claim 1, wherein updating the tally comprises updating the value t= [symbol] wherein [symbol] denotes the set of all confirmed votes.

10. A method according to claim 3, wherein updating the sum comprises updating the value s= [symbol] wherein [symbol] denotes the set of all confirmed votes.

11. A method according to claim 6, wherein updating the sum comprises updating the value s= [symbol] wherein [symbol] denotes the set of all confirmed votes.

12. A method according to claim 1, wherein the receipt comprises a signed receipt.

13. A method according to claim 1, wherein the method further comprises:
after the step of calculating the one or more second values, receiving a selection from the voter to either audit the vote or confirm the vote;
if the voter selects to confirm the vote, proceeding to the steps of providing a receipt including the one or more second values, updating the tally, updating the sum, and publishing the receipt; and
if the voter selects to audit the vote, performing the additional steps of: providing a second type of receipt including the one or more second values, the one or more first values, and the vote vᵢ to the voter; publishing the receipt including the one or more second values, the one or more first values, and the vote vᵢ; and returning to the step of receiving a selection of a vote.

14. A method according to claim 1, further comprising checking that the receipts provided to the voter match the published receipts.

15. A method according to claim 1, further comprising repeating the method for one or more further voters until all voters have confirmed their vote.

16. A method according to claim 1, further comprising:
computing one or more values based on the sum, s; and
publishing the one or more values based on the sum, s, and the final tally t.

17. A method according to claim 16, wherein computing one or more values based on the sum, s comprises computing S=g^{s} and P_{WF}{S:g,ĝ,_{j ,} [symbol] }.

18. A method according to claim 1 further comprising publishing the final sum, s, and the tally, t.

19. A method according to claim 1, further comprising verifying the validity of the published well-formedness proofs P_{WF}.

20. A method according to claim 1, further comprising verifying, for each published receipt including the one or more second values, the one or more first values and the vote vᵢ, that the one or more second values are consistent with the one or more first values and the vote vᵢ.

21. A method according to claim 1, further comprising verifying the final tally, t.

22. A method according to claim 21, wherein verifying the final tally, t, comprises verifying that the following equation holds:

[symbol]

23. A method according to claim 21, wherein verifying the final tally, t, comprises verifying that the following equations hold:
$${\prod }_{j ∈ ℂ} {R}_{j} = {g}_{2}^{s}$$
$${\prod }_{j ∈ ℂ} {Z}_{j} = {g}_{1}^{s} {g}_{1}^{t}$$

24. A system or apparatus configured for implementing a method according to claim 1.

25. A system or apparatus according to claim 24, wherein the system or apparatus comprises one or both of:
a Direct Recording Electronic (DRE) machine; and
a public bulletin board.
